(19) United States
(12) Patent Application Publication
(10) Pub. No.: US 2012/0311645 A1
(43) Pub. Date: Dec. 6, 2012

(54) VIDEO PROCESSING DEVICE, METHOD, RECORDING MEDIUM, AND INTEGRATED CIRCUIT

(76) Inventors: Toshihiko Munetsugu, Osaka (JP); Yuka Ozawa, Osaka (JP); Toru Kawaguchi, Osaka (JP); Hiroshi Yahata, Osaka (JP); Yasushi Uesaka, Hyogo (JP); Tomoki Ogawa, Osaka (JP)

(21) Appl. No.: 13/482,188

(22) Filed: May 29, 2012

Related U.S. Application Data
(60) Provisional application No. 61/492,050, filed on Jun. 1, 2011.

(51) Int. Cl. H04N 13/04; H04N 21/643; H04N 21/234

(52) U.S. Cl. 725/93; 348/51; 725/110; 348/E13.075; 348/E13.026

(57) ABSTRACT

A video processing device receives at least a supplementary display object playback stream and a data block, the supplementary display object playback stream containing an encoded supplementary display object to be displayed along with a 3D video image, and the data block including identifying information for 3D display of the supplementary display object by a processing unit. Before the content of the supplementary display object playback stream is referred to, the identifying information is extracted from the data block and the processing unit for 3D display of the supplementary display object is determined. The determined processing unit processes the supplementary display object playback stream to create and output a right-view supplementary display object and a left-view supplementary display object.

This application claims benefit to the U.S. Provisional Application 61/492,050 filed on Jun. 1, 2011.

### TECHNICAL FIELD

The present disclosure relates to technology for processing stream data, and in particular to technology for processing data, such as subtitles, to be displayed along with 3D video images.

### DESCRIPTION OF THE RELATED ART

During video distribution via a broadcast or over a network, such as the Internet, subtitles for digital video content, such as a movie, are distributed as separate data associated with the video data. A reception device displays the subtitles along with the digital video content.

In the case of 3D digital video content in which viewers see video images stereoscopically (hereinafter referred to as “3D video images”), subtitles are displayed along with the 3D video images in the same way as when displaying subtitles for digital video content without any mechanism for stereoscopic viewing of video images (hereinafter referred to as “2D video images”). 3D video images, however, may appear closer than or further behind the screen. Therefore, if subtitles are overlaid on 3D video images in the same way as on 2D video images, the subtitles may end up behind or in front of the 3D video images and thus appear awkward. To address this issue, processing technology has been proposed to position subtitles displayed along with 3D video images (hereinafter referred to as “3D subtitles”) appropriately in 3D space by using “1 plane+offset mode” and “2 plane+offset mode” (Non-Patent Literature 1). In addition to subtitles, display data distributed within a digital broadcast for display along with 2D video images and 3D video images may include superimposed text and display data for a data broadcast. The above processing technology may be applied when displaying such data along with 3D video images. Hereinafter, subtitles, superimposed text, display data for a data broadcast, and the like are collectively referred to as “display data for subtitles and the like”. Furthermore, the 1 plane+offset mode and the 2 plane+offset mode are collectively referred to as display modes for 3D subtitles and the like.

### CITATION LIST

### Non-Patent Literature

[Non-Patent Literature 1] Blu-ray Disc Association, “White Paper Blu-ray Disc Read-Only Format”, p. 39-p. 42, “6.3 3D graphics with 3D video”, [online], July 2010, Blu-ray Disc Association, [Retrieved Apr. 2, 2012], URL: http://www.blu-raydisc.com/assets/Downloadablefile/BD-ROM Audio Visual Application_Format_Specifications-18780.pdf

### SUMMARY

It can be determined whether the display mode for 3D subtitles and the like is 1 plane+offset mode or 2 plane+offset mode by analyzing the stream that includes the display data for subtitles and the like. However, analyzing the stream that includes the display data for subtitles and the like and then determining the display mode for 3D subtitles and the like results in a relatively long time for processing before the display data for subtitles and the like is displayed along with the 3D video images. It is therefore desirable that video processing devices can determine the display mode for 3D subtitles and the like quickly. One possibility is for a video distribution system to distribute a stream containing new information that allows for quick identification of the display mode for 3D subtitles and the like.

Video processing devices do not, however, support determination processing that uses such information. Therefore, such a new video distribution system cannot be effectively used. The development of a video processing device that supports a new video distribution system has thus become a pressing issue.

One non-limiting and exemplary embodiment provides a video distribution device that processes a stream that is distributed by a video distribution system and includes information allowing for quick identification of the display mode for 3D subtitles and the like, thereby quickly determining the display mode for 3D subtitles and the like.

In one general aspect, the techniques disclosed here feature a video processing device for displaying a supplementary display object along with a 3D video image, the video processing device comprising: a first processing unit operable to create and output a right-view supplementary display object and a left-view supplementary display object for 3D display of the supplementary display object based on information representing the supplementary display object with one plane; a second processing unit operable to create and output a right-view supplementary display object and a left-view supplementary display object for 3D display of the supplementary display object based on information representing the supplementary display object with two planes; a reception unit receiving at least a supplementary display object playback stream and a data block, the supplementary display object playback stream containing information representing the supplementary display object with one plane or with two planes, and the data block including identifying information indicating whether the supplementary display object is represented with one plane or with two planes; a selection unit extracting the identifying information from the data block before content of the supplementary display object playback stream is referred to and selecting one of the first processing unit and the second processing unit in accordance with the identifying information; and a control unit consecutively providing the one of the first processing unit and the second processing unit selected by the selection unit with information representing the supplementary display object contained in the content of the supplementary display object playback stream and causing the one of the first processing unit and the second processing unit selected by the selection unit to create and output the right-view supplementary display object and the left-view supplementary display object.

With the above structure, the video processing device quickly determines the display mode for 3D subtitles and the like by processing a stream, distributed by a video distribution system, that includes information allowing for quick identification of the display mode for 3D subtitles and the like.

These general and specific aspects may be implemented using a method, a recording medium having a program recording thereon, and an integrated circuit, and any combination of methods, recording media having a program recorded thereon, and integrated circuits.

Additional benefits and advantages of the disclosed embodiments will be apparent from the specification and Figures. The benefits and/or advantages may be individually provided by the various embodiments and features of the specification and drawings disclosure, and need not all be provided in order to obtain one or more of the same.

### BRIEF DESCRIPTION OF DRAWINGS

FIG. 1 illustrates the data structure of a PMT.

FIG. 2 illustrates the data structure of an arib_{—}3d_offsetmode_info descriptor.

FIG. 3 illustrates the relationship between the values of the subtitle_offset_mode and the bml_offset_mode and the display mode for 3D subtitles and the like.

FIG. 4 is a block diagram illustrating the functional structure of a video processing device 300 according to an embodiment of the present disclosure.

FIG. 5 is a functional block diagram of a subtitle processor 309.

FIG. 6 is a functional block diagram of a data broadcast processor 310.

FIG. 7 is a flowchart illustrating processing by the video processing device 300.

FIG. 8 is a flowchart illustrating processing by a determination unit 304 in Embodiment 1.

FIG. 9 illustrates a first modification to the data structure of an arib_{—}3d_offsetmode_info descriptor.

FIG. 10 illustrates the relationship between the values of the subtitle_offset_mode and the bml_offset_mode and the display mode for 3D subtitles and the like in the modification in FIG. 9.

FIG. 11 illustrates a second modification to the data structure of an arib_{—}3d_offsetmode_info descriptor.

FIG. 12 illustrates the concept of 1 plane+offset mode.

FIG. 13 illustrates the concept of 2 plane+offset mode.

FIG. 14 is a block diagram illustrating the functional structure of a multiplexing device 3000.

FIG. 15 illustrates the data structure of a data component descriptor.

FIG. 16 illustrates the relationship between the value of the data_component_id and the display mode for 3D subtitles and the like.

FIG. 17 is a flowchart illustrating processing by the determination unit 304 in Embodiment 2.

FIG. 18 illustrates the data structure of additional_arib_bxml_info.

FIG. 19 illustrates the data structure of additional_arib_carousel_info.

FIG. 20 illustrates the data structure of an EIT.

FIG. 21 illustrates the data structure of a data content descriptor.

FIG. 22 is a flowchart illustrating processing by the determination unit 304 in Embodiment 5.

FIG. 23 illustrates the data structure of arib_bxml_info.

FIG. 24 illustrates the structure of data described in the arib_carousel_info in the arib_bxml_info.

FIG. 25 illustrates the data structure of ERI.

FIG. 26 illustrates the configuration of an electronic video distribution system 2200.

FIG. 27 shows the processing sequence by the electronic video distribution system 2200.

FIG. 28A illustrates a first modification to a tag in the ERI describing identifying information for the display mode for 3D subtitles and the like, and FIG. 28B illustrates a second modification thereto.

FIG. 29 illustrates the data structure of ECG metadata.

FIG. 30 illustrates a modification to a tag in the ECG metadata describing identifying information for the display mode for 3D subtitles and the like.

FIG. 31A illustrates an example of an HTTP-GET request transmitted by a video processing device; FIG. 31B illustrates an example of a header of the HTTP response in the case of 1 plane+offset mode; and FIG. 31C illustrates an example of a header of the HTTP response header in the case of 2 plane+offset mode.

FIG. 32 illustrates the configuration of a data broadcast data provision server in Embodiment 9.

### DETAILED DESCRIPTION

Process by which an Aspect of the Present Disclosure was Achieved

Viewers of 3D video images perceive the images as being closer than the screen or further away, unlike when viewing monoscopic 2D video images.

When display data for subtitles and the like is displayed along with such 3D video images, the display data for subtitles and the like may appear awkward if not displayed at a position in 3D space that appropriately matches the 3D video images.

One method for displaying display data for subtitles and the like appropriately in 3D space along with 3D video images is the 1 plane+offset mode and the 2 plane+offset mode (details on these display modes for 3D subtitles and the like are provided below). It cannot be determined, however, which mode is to be used to process the display data for subtitles and the like without analyzing the stream that contains the display data for subtitles and the like.

The processing method for each of the display modes for 3D subtitles and the like differs. Different resources, such as the number of decoders and amount of memory, are thus necessary for processing. These resources are shared by other processes in the video processing device (such as processes for background recording of a program or dubbing of a recorded program). When these processes are performed, arbitration between processes is necessary for reservation of resources. Therefore, before data is displayed along with the 3D video images, it takes some time to perform the analysis, reserve resources, and process data.

By focusing on the data block that the video processing device refers to before processing the stream with the display data for subtitles and the like, the inventors conceived of a system to distribute data that describes, in this data block, information for identification of the display mode for 3D subtitles and the like (hereinafter referred to as “mode identifying information”). With this system, mode identifying information is distributed by inclusion in a data block that is processed before processing of data that includes display data to be displayed along with 3D video images. Therefore, before analyzing and processing the display data to be displayed along with 3D video images, the video processing device can identify the display mode for 3D subtitles and the like based on the mode identifying information and start to reserve the resources necessary for the corresponding mode. This shortens the amount of time before the display data for subtitles and the like, which is to be displayed along with the 3D video images, is actually displayed along with the 3D video images.

The following describes embodiments of the present disclosure with reference to the drawings.

### Embodiment 1

### 1.1 Outline

A video processing device according to an embodiment of the present disclosure receives a data stream in MPEG2-TS (Transport Stream) format, which is used in broadcast and data distribution.

The transmitter (such as a broadcasting station) of the data stream encodes the 3D video image data, audio data, subtitle data, data for a data broadcast, and the like which constitute a program, and generates an ES (Elementary Stream) for each piece of data. The transmitter then distributes the multiplexed data stream, which is generated by multiplexing those ES. Note that the concept of “content” in the present embodiment includes such programs for broadcast or data distribution. Also note that a multiplexing device for generating the multiplexed data stream is described below. The transmitter of the data stream puts the mode identifying information in SI (Service Information)/PSI (Program Specific Information), which is included in a conventional MPEG2-TS data stream.

The video processing device determines the display mode for 3D subtitles and the like by extracting and analyzing the mode identifying information, contained in the SI/PSI that is included in the received data stream, before processing the stream that includes the display data for subtitles and the like.

### 1.2 Data

The following describes the data structure of data in the present embodiment.

The present embodiment adopts the SI/PSI information specified by the MPEG2-TS standards. SI is a collective term for tables in which information on a program is encoded in a format that the video processing device can interpret. The SI is specified by the ARIB (Association of Radio Industries and Businesses) and includes, for example, tables such as an NIT (Network Information Table) and an EIT (Event Information Table).

PSI is a collective term for tables in which information regarding the program to which each ES included in a TS belongs is encoded in a format that the video processing device can interpret. The PSI is specified by standards established by ISO/IEC13818-1 and the ARIB and includes, for example, tables such as a PAT (Program Association Table) and a PMT (Program Map Table).

In Embodiment 1, the PMT is used as the table describing the mode identifying information.

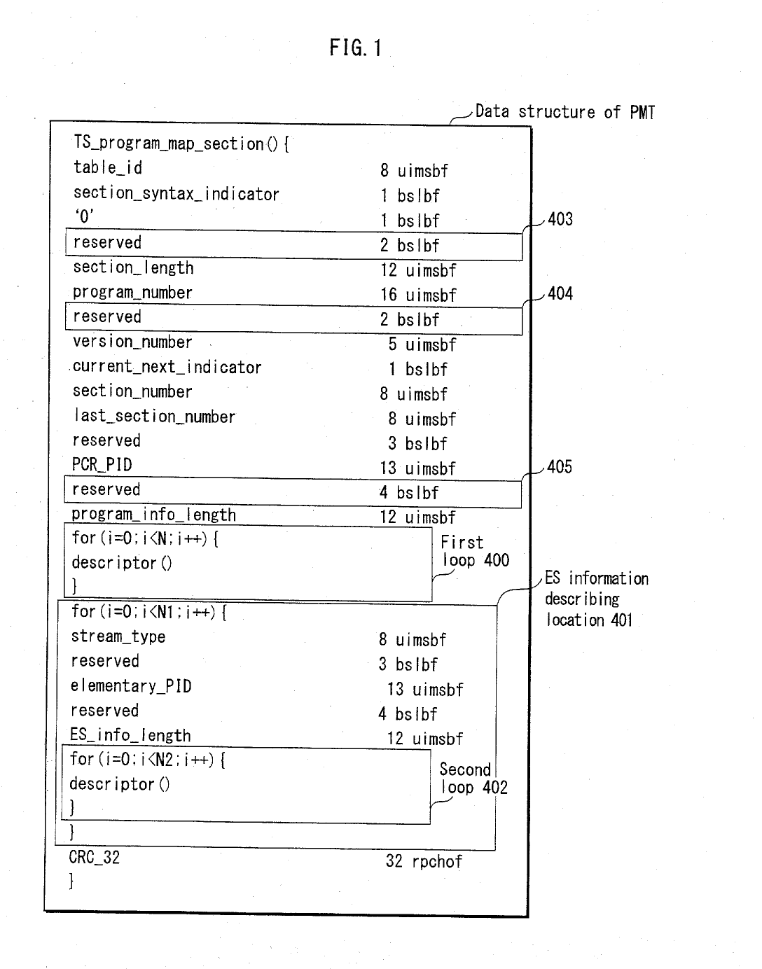

FIG. 1 shows the data structure of the PMT.

The PMT stores information on the distributed program, the ES structure of the program, and information on each ES.

A description of individual fields can be found in ISO/IEC13818-1 (MPEG-2) and is therefore omitted here. Only the portion that is relevant to the present embodiment is described.

In the PMT of FIG. 1, a descriptor can be described in the descriptor( ) of a first loop 400 and in the descriptor( ) of a second loop 402.

In the present embodiment, the display mode for 3D subtitles and the like is assumed not to change during a program. Therefore, a new descriptor arib_{—}3d_offsetmode_info is described in the first loop 400 of the PMT where descriptors that relate to information on the entire program are described. This descriptor describes a subtitle_offset_mode and a bml_offset_mode as the mode identifying information and is used for determination of the display mode for 3D subtitles and the like.

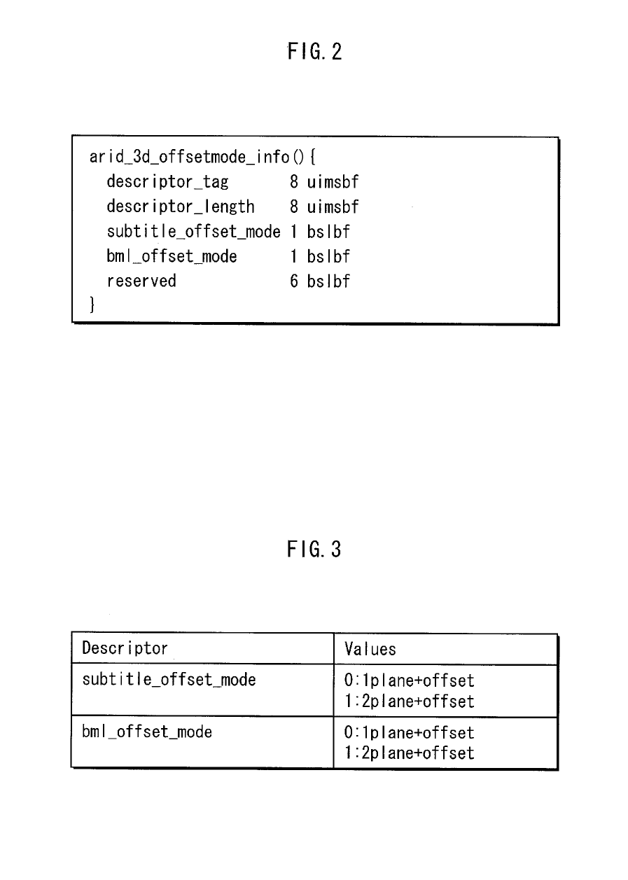

FIG. 2 shows the data structure of the arib_{—}3d_offsetmode_info descriptor.

In the arib_{—}3d_offsetmode_info descriptor, a subtitle_offset_mode, which is a one-bit field, is the field used for identifying the display mode for 3D subtitles and the like in the case of subtitles, and a bml_offset_mode, which is a one-bit field, is the field used for identifying the display mode for 3D subtitles and the like in the case of a data broadcast.

FIG. 3 shows the relationship between the values of the subtitle_offset_mode and the bml_offset_mode and the display modes for 3D subtitles and the like. As shown in FIG. 3, a value of “0” for the subtitle_offset_mode or the bml_offset_mode indicates the 1 plane+offset mode, whereas a value of “1” indicates the 2 plane+offset mode.

A video processing device 300 according to the present embodiment receives a PMT in which the arib_{—}3d_offsetmode_info descriptor shown in FIG. 2 is described in the descriptor( ) of the first loop 400 in FIG. 1.

### 1.3 Structure

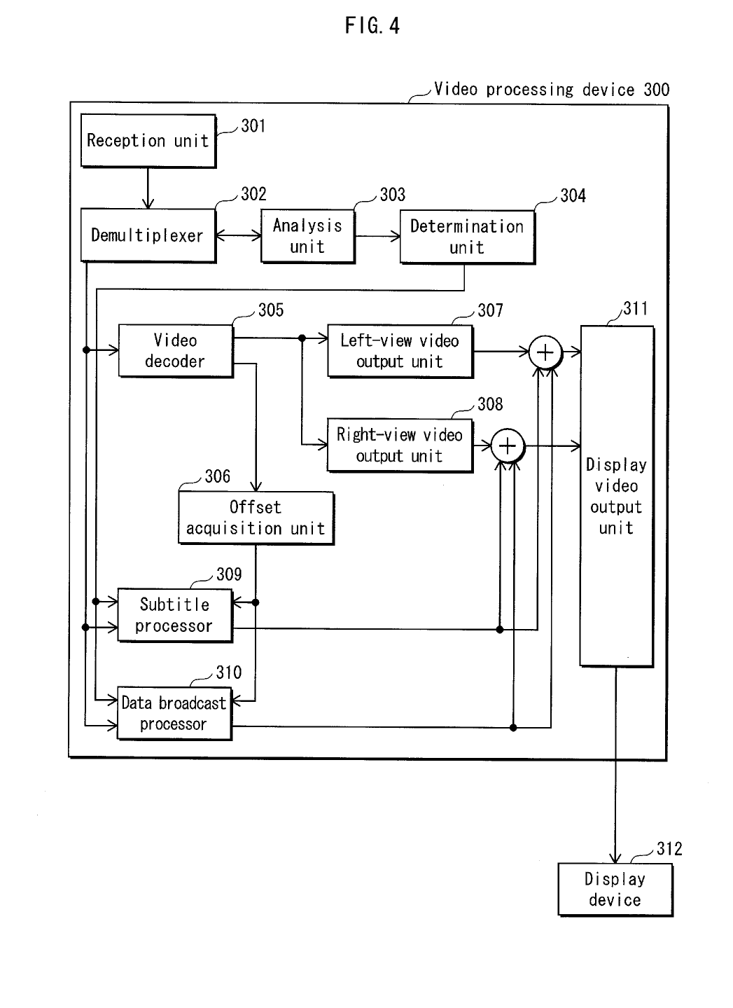

FIG. 4 is a functional block diagram of the video processing device 300 according to Embodiment 1 of the present disclosure.

The video processing device 300 includes a reception unit 301, a demultiplexer 302, an analysis unit 303, a determination unit 304, a video decoder 305, an offset acquisition unit 306, a left-view video output unit 307, a right-view video output unit 308, a subtitle processor 309, a data broadcast processor 310, and a display video output unit 311.

The video processing device 300 includes a processor, RAM (Random Access Memory), ROM (Read Only Memory), and a hard disk not shown in the figures. The functional blocks of the video processing device 300 are either configured as hardware or are achieved by the processor executing programs stored in the ROM or on the hard disk.

### Reception Unit 301

The reception unit 301 is a tuner that receives stream data in MPEG2-TS format, distributed by a broadcasting station or a distribution center. Demultiplexer 302

The demultiplexer 302 has a function to extract the PAT from the MPEG2-TS stream data received by the reception unit 301 and output the PAT to the analysis unit 303. The demultiplexer 302 also has a function to output TS packets having the PID of the PMT to the analysis unit 303 in accordance with information on the PID of the PMT obtained by the analysis unit 303 analyzing the PAT. Furthermore, the demultiplexer 302 has a function to select the PID, as acquired by the analysis unit 303 analyzing the PMT, of TS packets that pertain to the program to be played back. Additionally, the demultiplexer 302 has the function to sort and output packets with SI/PSI information to the analysis unit 303, packets with video data to the video decoder 305, packets with subtitle data to the subtitle processor 309, and packets with data on a data broadcast to the data broadcast processor 310.

### Analysis Unit 303

The analysis unit 303 has a function to analyze the content of the SI/PSI, such as the PAT, the PMT, the NIT, the EIT, a BIT (Broadcaster Information Table), and the like; a function to output the PIDs of the PMT of the program for playback, as obtained by analyzing the PAT, to the demultiplexer 302; a function to output the PIDs of data such as video and audio constituting the program for playback, as obtained by analyzing the PMT, to the demultiplexer 302; and a function to output the mode identifying information obtained by analyzing the PMT to the determination unit 304.

### Determination Unit 304

Based on the mode identifying information output by the analysis unit 303, the determination unit 304 has a function to select the display mode for 3D subtitles and the like to be used for data processing by the subtitle processor 309 and the data broadcast processor 310 and to output the result of selection to the subtitle processor 309 and to the data broadcast processor 310. The determination unit 304 also has a function to reserve decoders and plane memory necessary for processing for the selected display mode for 3D subtitles and the like.

### Video Decoder 305

The video decoder 305 has a function to extract encoded 3D video data from the TS packets that include 3D video data and that have been sorted by and input from the demultiplexer 302 and to decode the extracted data. The video decoder 305 also has a function to output left-view video frames to the left-view video output unit 307 and right-view video frames to the right-view video output unit 308. For example, the video decoder 305 decodes 3D video images in a side-by-side format or 3D video images in MPEG4-MVC format.

### Offset Acquisition Unit 306

The offset acquisition unit 306 has a function to acquire an offset value that is included in the TS packets that include the 3D video which is decoded by the video decoder 305. The offset value is used during processing for 3D display of data for subtitles and the like to be displayed along with the 3D video images. The offset acquisition unit 306 also has a function to output the acquired offset value to the subtitle processor 309 if subtitle data exists and to output the acquired offset value to the data broadcast processor 310 if display data for a data broadcast exists.

### Left-View Video Output Unit 307

The left-view video output unit 307 has a function to output, to the display video output unit 311, the left-view video frame output by the video decoder 305. If a left-view subtitle video image or a left-view data broadcast video image exists, the left-view video frame is combined with these video images before being output to the display video output unit 311 as a left-view video image.

### Right-View Video Output Unit 308

The right-view video output unit 308 has a function to output, to the display video output unit 311, the right-view video frame output by the video decoder 305. If a right-view subtitle video image or a right-view data broadcast video image exists, the right-view video frame is combined with these video images before being output to the display video output unit 311 as a right-view video image.

### Subtitle Processor 309

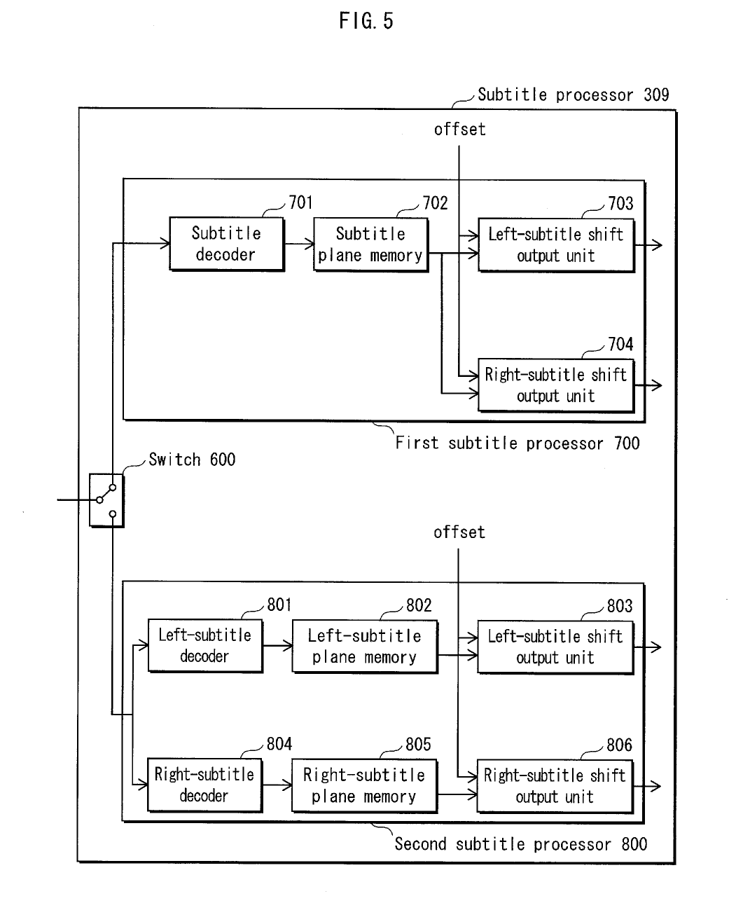

FIG. 5 is a functional block diagram of the subtitle processor 309.

The subtitle processor 309 includes a first subtitle processor 700, a second subtitle processor 800, and a switch 600.

The switch 600 has a function to switch the destination of output of packets that include subtitle display data, as sorted by and input from the demultiplexer 302, between the first subtitle processor 700 and the second subtitle processor 800 in accordance with the results of determination by the determination unit 304.

The first subtitle processor 700 is for processing, for the 1 plane+offset mode, of packets that include subtitle display data. The first subtitle processor 700 includes a subtitle decoder 701, a subtitle plane memory 702, a left-subtitle shift output unit 703, and a right-subtitle shift output unit 704.

The subtitle decoder 701 generates a subtitle plane video image by decoding encoded subtitle data contained in the packets as sorted out from the MPEG2-TS stream data by the demultiplexer 302.

The subtitle plane memory 702 is a region yielded by the determination unit 304 allocating a portion of a recording medium, such as RAM, in the video processing device 300. The subtitle plane memory 702 stores a subtitle plane video image generated by the subtitle decoder 701.

In accordance with the offset value acquired by the offset acquisition unit 306, the left-subtitle shift output unit 703 shifts the subtitle plane video image stored by the subtitle plane memory 702 and outputs a resulting left-view subtitle video image.

In accordance with the offset value acquired by the offset acquisition unit 306, the right-subtitle shift output unit 704 shifts the subtitle plane video image stored by the subtitle plane memory 702 and outputs a resulting right-view subtitle video image.

The second subtitle processor 800 is for processing, for the 2 plane+offset mode, of packets that include subtitle display data. The second subtitle processor 800 includes a left-subtitle decoder 801, a left-subtitle plane memory 802, a left-subtitle shift output unit 803, a right-subtitle decoder 804, a right-subtitle plane memory 805, and a right-subtitle shift output unit 806.

The left-subtitle decoder 801 generates a left-subtitle plane video image by decoding encoded left-view subtitle data contained in the packets as sorted out from the MPEG2-TS stream data by the demultiplexer 302.

The left-subtitle plane memory 802 is a region yielded by the determination unit 304 allocating a portion of a recording medium, such as RAM, in the video processing device 300. The left-subtitle plane memory 802 stores a left-subtitle plane video image generated by the left-subtitle decoder 801.

In accordance with the offset value acquired by the offset acquisition unit 306, the left-subtitle shift output unit 803 shifts the left-subtitle plane video image stored by the left-subtitle plane memory 802 and outputs a resulting left-view subtitle video image.

The right-subtitle decoder 804 generates a right-subtitle plane video image by decoding encoded right-view subtitle data in the packets as sorted out from the MPEG2-TS stream data by the demultiplexer 302.

The right-subtitle plane memory 805 is a region yielded by the determination unit 304 allocating a portion of a recording medium, such as RAM, in the video processing device 300. The right-subtitle plane memory 805 stores a right-subtitle plane video image generated by the right-subtitle decoder 804.

In accordance with the offset value acquired by the offset acquisition unit 306, the right-subtitle shift output unit 806 shifts the right-subtitle plane video image stored by the right-subtitle plane memory 805 and outputs a resulting right-view subtitle video image.

Note that the structure of the subtitle processor 309 shown in FIG. 5 is a logical structure. The physical subtitle decoders corresponding to the subtitle decoder 701, the left-subtitle decoder 801, and the right-subtitle decoder 804 are allocated each time the determination unit 304 performs processing. Therefore, a certain physical subtitle decoder need not be allocated every time to the same one of the subtitle decoder 701, the left-subtitle decoder 801, and the right-subtitle decoder 804. Rather, a physical subtitle decoder may be allocated to any of these subtitle decoders. Similarly, the physical memory areas corresponding to the subtitle plane memory 702, the left-subtitle plane memory 802, and the right-subtitle plane memory 805 are allocated each time the determination unit 304 performs processing. Therefore, a certain physical memory area need not be allocated every time to the same one of the subtitle plane memory 702, the left-subtitle plane memory 802, and the right-subtitle plane memory 805. Rather, a physical memory area may be allocated to any of these plane memories. Furthermore, the left-subtitle shift output unit 703 and the left-subtitle shift output unit 803 may physically be the same. The right-subtitle shift output unit 704 and the right-subtitle shift output unit 806 may also physically be the same.

### Data Broadcast Processor 310

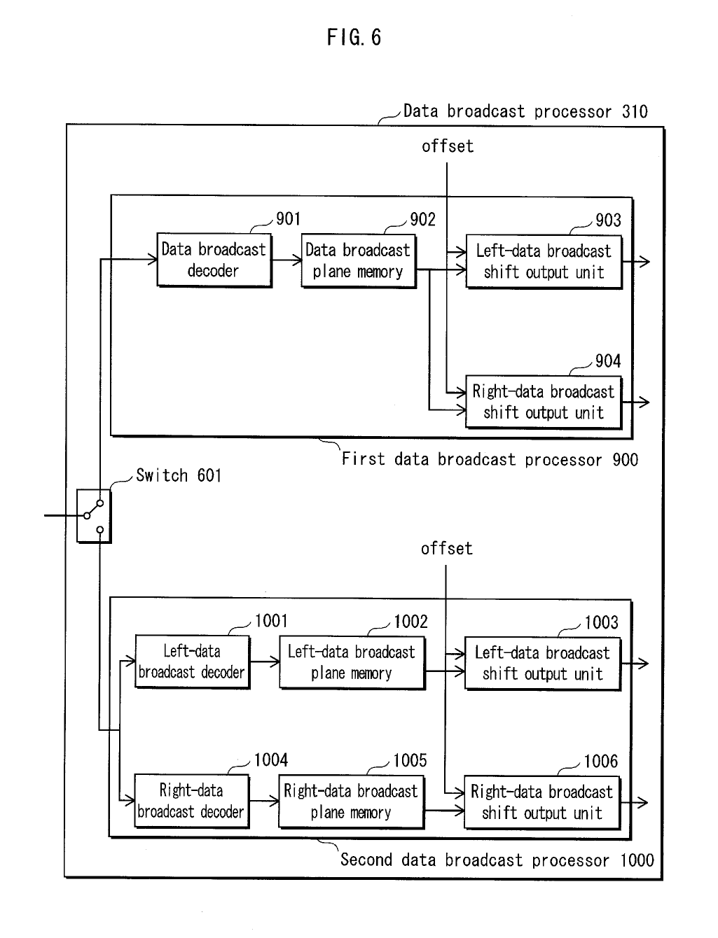

FIG. 6 is a functional block diagram of the data broadcast processor 310.

The data broadcast processor 310 includes a first data broadcast processor 900, a second data broadcast processor 1000, and a switch 601.

The switch 601 has a function to switch the destination of output of packets that include data for a data broadcast, as sorted by and input from the demultiplexer 302, between the first data broadcast processor 900 and the second data broadcast processor 1000 in accordance with the results of determination by the determination unit 304.

The first data broadcast processor 900 is for processing, for the 1 plane+offset mode, of data packets for a data broadcast.

The first data broadcast processor 900 includes a data broadcast decoder 901, a data broadcast plane memory 902, a left-data broadcast shift output unit 903, and a right-data broadcast shift output unit 904.

The data broadcast decoder 901 generates a data broadcast plane video image by decoding encoded data for a data broadcast in the packets as sorted out from the MPEG2-TS stream data by the demultiplexer 302.

The data broadcast plane memory 902 is a region yielded by the determination unit 304 allocating a portion of a recording medium, such as RAM, in the video processing device 300. The data broadcast plane memory 902 stores a data broadcast plane video image generated by the data broadcast decoder 901.

In accordance with the offset value acquired by the offset acquisition unit 306, the left-data broadcast shift output unit 903 shifts the data broadcast plane video image stored by the data broadcast plane memory 902 and outputs a resulting left-view data broadcast video image.

In accordance with the offset value acquired by the offset acquisition unit 306, the right-data broadcast shift output unit 904 shifts the data broadcast plane video image stored by the data broadcast plane memory 902 and outputs a resulting right-view data broadcast video image.

The second data broadcast processor 1000 is for processing, for the 2 plane+offset mode, of data packets for a data broadcast. The second data broadcast processor 1000 includes a left-data broadcast decoder 1001, a left-data broadcast plane memory 1002, a left-data broadcast shift output unit 1003, a right-data broadcast decoder 1004, a right-data broadcast plane memory 1005, and a right-data broadcast shift output unit 1006.

The left-data broadcast decoder 1001 generates a left-data broadcast plane video image by decoding encoded left-view data for a data broadcast in the packets as sorted out from the MPEG2-TS stream data by the demultiplexer 302.

The left-data broadcast plane memory 1002 is a region yielded by the determination unit 304 allocating a portion of a recording medium, such as RAM, in the video processing device 300. The left-data broadcast plane memory 1002 stores a left-data broadcast plane video image generated by the left-data broadcast decoder 1001.

In accordance with the offset value acquired by the offset acquisition unit 306, the left-data broadcast shift output unit 1003 shifts the left-data broadcast plane video image stored by the left-data broadcast plane memory 1002 and outputs a resulting left-view data broadcast video image.

The right-data broadcast decoder 1004 generates a right-data broadcast plane video image by decoding encoded data for a right-view data broadcast in the packets as sorted out from the MPEG2-TS stream data by the demultiplexer 302.

The right-data broadcast plane memory 1005 is a region yielded by the determination unit 304 allocating a portion of a recording medium, such as RAM, in the video processing device 300. The right-data broadcast plane memory 1005 stores a right-data broadcast plane video image generated by the right-data broadcast decoder 1004.

In accordance with the offset value acquired by the offset acquisition unit 306, the right-data broadcast shift output unit 1006 shifts the right-data broadcast plane video image stored by the right-data broadcast plane memory 1005 and outputs a resulting right-view data broadcast video image.

Note that the structure of the data broadcast processor 310 shown in FIG. 6 is a logical structure. The physical data broadcast decoders corresponding to the data broadcast decoder 901, the left-data broadcast decoder 1001, and the right-data broadcast decoder 1004 are allocated each time the determination unit 304 performs processing. Therefore, a certain physical data broadcast decoder need not be allocated every time to the same one of the data broadcast decoder 901, the left-data broadcast decoder 1001, and the right-data broadcast decoder 1004. Rather, a physical data broadcast decoder may be allocated to any of these broadcast decoders. Similarly, the physical memory areas corresponding to the data broadcast plane memory 902, the left-data broadcast plane memory 1002, and the right-data broadcast plane memory 1005 are allocated each time the determination unit 304 performs processing. Therefore, a certain physical memory area need not be allocated every time to the same one of the data broadcast plane memory 902, the left-data broadcast plane memory 1002, and the right-data broadcast plane memory 1005. Rather, a physical memory area may be allocated to any of these plane memories. Furthermore, the left-data broadcast shift output unit 903 and the left-data broadcast shift output unit 1003 may physically be the same. The right-data broadcast shift output unit 904 and the right-data broadcast shift output unit 1006 may also physically be the same.

### Display Video Output Unit 311

The display video output unit 311 has a function to combine the display data output by the left-view video output unit 307, the right-view video output unit 308, the subtitle processor 309, and the data broadcast processor 310 and to output the resulting left-view video image and right-view video image to an external display device 312.

The display device 312 has a function to allow for viewing of the output left-view video image and right-view video image as a 3D video image. The display device 312 is, for example, a television supporting 3D video.

### 1.4 Operations

The following describes operations by the video processing device 300 for an example of receipt of a broadcast.

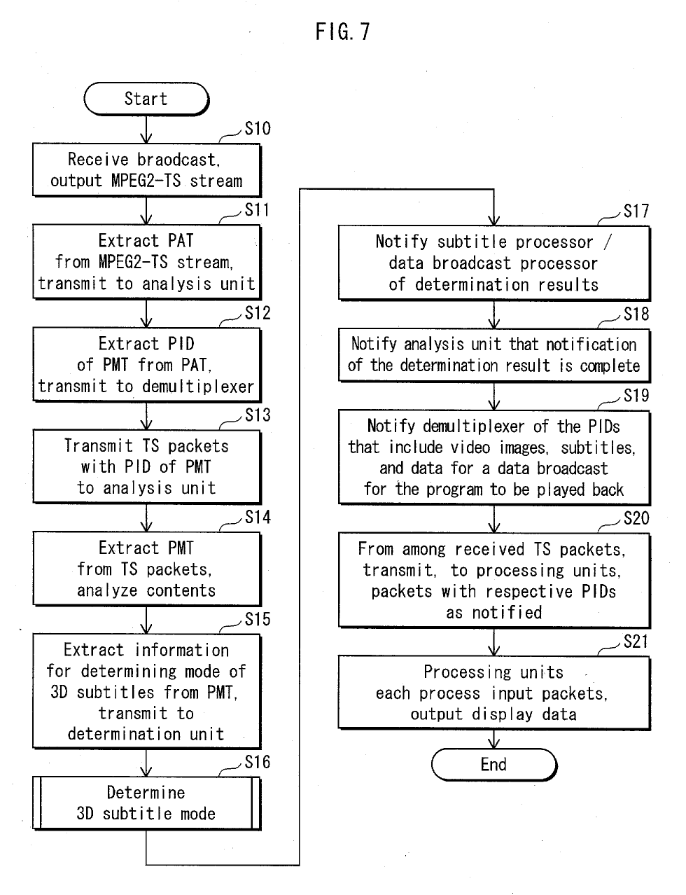

FIG. 7 is a flowchart showing processing by the video processing device.

First, the reception unit 301 receives a broadcast and outputs the MPEG2-TS stream included in the broadcast to the demultiplexer 302 (step S10).

The demultiplexer 302 extracts the TS packets of the PAT from the MPEG2-TS stream, outputting the TS packets to the analysis unit 303 (step S11).

The analysis unit 303 extracts and analyzes the PAT from the TS packets input from the demultiplexer 302 to obtain the PID of the PMT pertaining to the program to be played back. The analysis unit 303 then notifies the demultiplexer 302 of the PID (step S12).

The demultiplexer 302 outputs TS packets with the PID of the PMT to the analysis unit 303 (step S13).

The analysis unit 303 extracts the PMT from the received TS packets and analyzes the content of the PMT (step S14).

The analysis unit 303 checks whether the arib_{—}3d_offsetmode_info descriptor is described in the first loop 400 of the PMT. If the arib_{—}3d_offsetmode_info descriptor is described, the analysis unit 303 outputs the content of the arib_{—}3d_offsetmode_info descriptor to the determination unit 304 (step S15).

The determination unit 304 analyzes the content of the arib_{—}3d_offsetmode_info to determine the display mode for 3D subtitles and the like to be used by the subtitle processor 309 and the data broadcast processor 310 (step S16). Note that details on the processing in step S16 are provided below.

The determination unit 304 notifies the subtitle processor 309 and the data broadcast processor 310 of the results of determination (step S17). The determination unit 304 also notifies the analysis unit 303 that notification of the determination result is complete (step S18).

Upon being notified that notification of the determination result is complete, the analysis unit 303 notifies the demultiplexer 302 of the PIDs of the ES's that include video images, subtitles, and display data for a data broadcast for the program to be played back (step S19). Note that the PIDs of these ES's are acquired by analysis of the PMT.

From among the received TS packets, the demultiplexer 302 outputs, to the video decoder 305, the subtitle processor 309, and the data broadcast processor 310, TS packets having respective PIDs as notified by the analysis unit 303 (step S20).

Having received input of the TS packets, the video decoder 305, the subtitle processor 309, and the data broadcast processor 310 respectively extract video data, subtitle data, and data for a data broadcast from the input TS packets, generating and outputting video images for display (step S21). These video images for display are combined and then output by the display video output unit 311.

The following explains details on operations by the determination unit 304 in step S16.

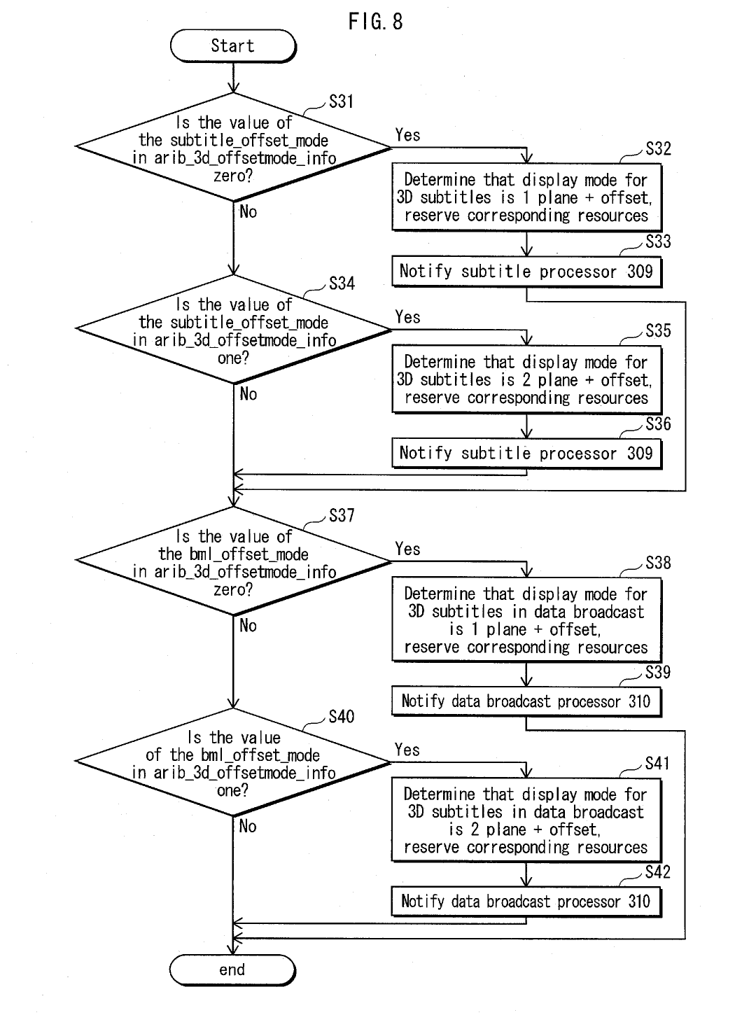

FIG. 8 is a flowchart showing details on the processing by the determination unit 304 in step S16.

The determination unit 304 determines whether the value of the subtitle_offset_mode in the arib_{—}3d_offsetmode_info transmitted by the analysis unit 303 is “0”. If the value is “0” (step S31: Yes), the determination unit 304 determines that the display mode for 3D subtitles and the like in the subtitle processor 309 is 1 plane+offset mode and reserves the decoder and memory necessary for processing by the subtitle processor 309 (step S32). Next, the determination unit 304 notifies the subtitle processor 309 of the results of determination (step S33). Upon completion of step S33, processing proceeds to step S37.

On the other hand, if the result of step S31 is “No”, the determination unit 304 determines whether the value of the subtitle_offset_mode in the arib_{—}3d_offsetmode_info is “1”. If the value is “1” (step S34: Yes), the determination unit 304 determines that the display mode for 3D subtitles and the like in the subtitle processor 309 is 2 plane+offset mode and reserves the decoders and memory necessary for processing by the subtitle processor 309 (step S35). Next, the determination unit 304 notifies the subtitle processor 309 of the results of determination (step S36). Upon completion of step S36, processing proceeds to step S37.

On the other hand, when the result of step S34 is “No”, processing proceeds to step S37.

When the processing in step S33 or step S36 is complete, or when the result of step S34 is “No”, the determination unit 304 determines whether the value of the bml_offset_mode in the arib_{—}3d_offsetmode_info is “0”. If the value is “0” (step S37: Yes), the determination unit 304 determines that the display mode for 3D subtitles and the like in the data broadcast processor 310 is 1 plane+offset mode and reserves the decoder and memory necessary for processing by the data broadcast processor 310 (step S38). Next, the determination unit 304 notifies the data broadcast processor 310 of the results of determination (step S39).

On the other hand, when the result of step S37 is “No”, the determination unit 304 determines whether the value of the bml_offset_mode in the arib_{—}3d_offsetmode_info is “1”. If the value is “1” (step S40: Yes), the determination unit 304 determines that the display mode for 3D subtitles and the like in the data broadcast processor 310 is 2 plane+offset mode and reserves the decoders and memory necessary for processing by the data broadcast processor 310 (step S41). Next, the determination unit 304 notifies the data broadcast processor 310 of the results of determination (step S42).

### 1.5 Modifications to Embodiment 1

(1) The name of the newly defined descriptor need not be arib_{—}3d_offsetmode_info. Any name may be used, as long as the name differs from the names of descriptors already defined in the standards and indicates that the descriptor describes the mode identifying information. Similarly, other names may be used for the subtitle_offset_mode and the bml_offset_mode.

(2) In the above embodiment, information for determining the display mode for 3D subtitles and the like in the case of subtitles and of a data broadcast is provided as one-bit fields in the arib_{—}3d_offsetmode_info descriptor, namely subtitle_offset_mode and bml_offset_mode. This information is not limited, however, to being described as one-bit fields. The information need not be one bit, as long as the information allows for identification of the display mode for 3D subtitles and the like.

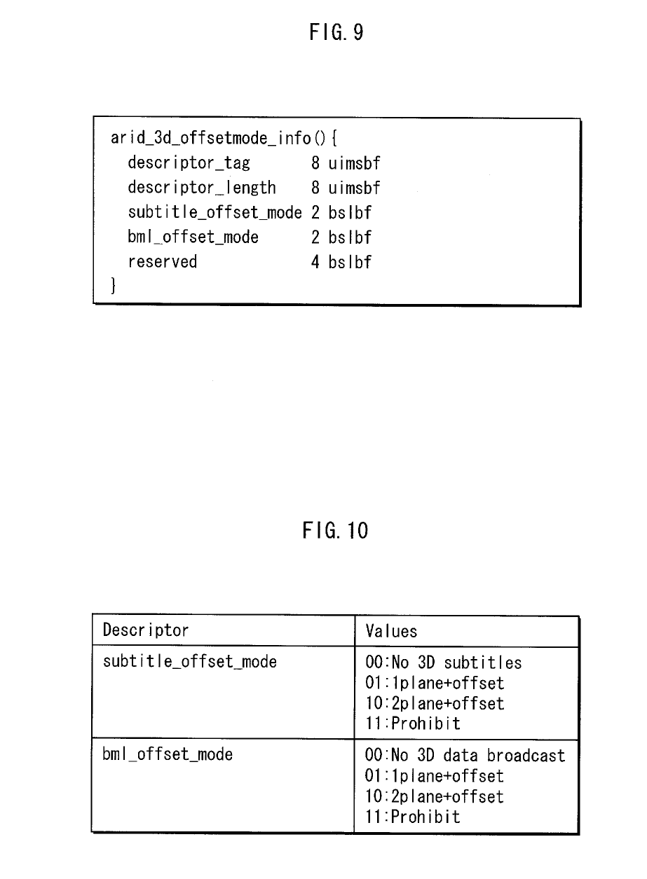

For example, as shown in FIG. 9, two bits may be assigned each to the subtitle_offset_mode and the bml_offset_mode in the arib_{—}3d_offsetmode_info descriptor. These fields may then be assigned values as in FIG. 10. The meanings of the values assigned to the subtitle_offset_mode and the bml_offset_mode are as follows. A value of “00” indicates that 3D subtitles or data for a 3D data broadcast do not exist in the content. A value of “01” indicates that the display mode for 3D subtitles and the like is 1 plane+offset mode. A value of “10” indicates that the display mode for 3D subtitles and the like is 2 plane+offset mode. A value of “11” is not used in the subtitle_offset_mode and the bml_offset_mode because the value is prohibited.

Note that when a plurality of subtitles (such both subtitles using 1 plane+offset mode and subtitles using 2 plane+offset mode) are provided, the value of “11” may be used to indicate that both 1 plane+offset mode data and 2 plane+offset mode data exists. In this case, processing may be performed in 1 plane+offset mode when resources necessary for processing of subtitles and the like in 2 plane+offset mode cannot be reserved. Furthermore, the user may be prompted to select which display mode for 3D subtitles and the like to use, with processing being performed in the mode selected by the user. The same method as described above for the subtitle_offset_mode may also be used for processing of the display data for a data broadcast in the bml_offset_mode.

(3) The data structure of the arib_{—}3d_offsetmode_info descriptor has been described as shown in FIG. 2, but any data structure may be adopted, as long as the data structure includes a field that allows for identification of the display mode for 3D subtitles and the like.

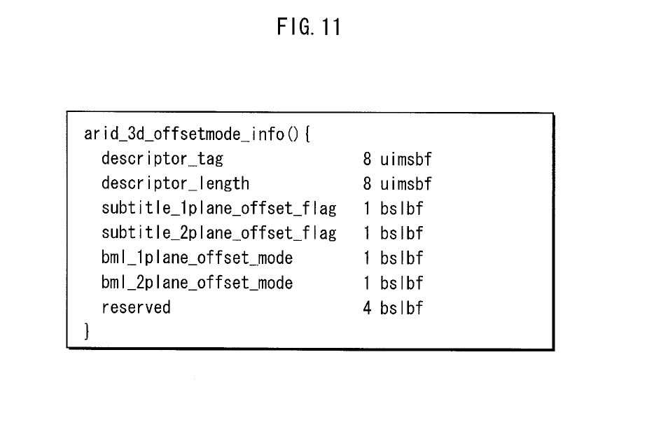

For example, the data structure in FIG. 11 may be used.

In FIG. 11, the subtitle_{—}1plan_offset_flag is a one-bit field. A value of “0” indicates that the display mode for 3D subtitles and the like is not 1 plane+offset mode, whereas a value of “1” indicates that the display mode for 3D subtitles and the like is 1 plane+offset mode.

Similarly, the subtitle_{—}2plan_offset_flag is a one-bit field. A value of “0” indicates that the display mode for 3D subtitles and the like is not 2 plane+offset mode, whereas a value of “1” indicates that the display mode for 3D subtitles and the like is 2 plane+offset mode.

Note that a value of “0” for both the subtitle_{—}1plane_offset_flag and the subtitle_{—}2plane_offset_flag may be used to indicate that no display data for 3D subtitles is attached.

(4) Furthermore, in the data structure of FIG. 11, a constraint may be introduced that the subtitle_{—}1plane_offset_flag and the subtitle_{—}2plane_offset_flag cannot both be a value of “0” or a value of “1” when only one set of 3D subtitles is always attached to a program.

(5) On the other hand, in the data structure shown in FIG. 11, if a plurality of 3D subtitles (such as an English subtitle and a Japanese subtitle) are attached to a program, the value of the subtitle_{—}1plane_offset_flag may be set to “1” if the display mode for 3D subtitles and the like is 1 plane+offset mode for any of the 3D subtitles, and the value of the subtitle_{—}1plane_offset_flag may be set to “0” if the display mode for 3D subtitles and the like is not 1 plane+offset mode for all of the 3D subtitles. Furthermore, the value of the subtitle_{—}2plane_offset_flag may be set to “1” if the display mode for 3D subtitles and the like is 2 plane+offset mode for any of the 3D subtitles, and the value of the subtitle_{—}2plane_offset_flag may be set to “0” if the display mode for 3D subtitles and the like is not 2 plane+offset mode for all of the 3D subtitles. The display mode for 3D subtitles and the like may then be determined using these values.

(6) In FIG. 11, the bml_{—}1plan_offset_flag and the bml_{—}2plane_offset_flag are for identifying the display mode for 3D subtitles and the like when display data in a 3D data broadcast is displayed in 3D. The bml_{—}1plan_offset_flag corresponds to the subtitle_{—}1plane_offset_flag for 3D subtitles, and the bml_{—}2plane_offset_flag similarly corresponds to the subtitle_{—}2plane_offset_flag. Therefore, the same methods as described above for the subtitle_{—}1plane_offset_flag and the subtitle_{—}2plane_offset_flag may be used to determine the display mode for 3D subtitles and the like in the case of display data in a data broadcast.

(7) In the present embodiment, the arib_{—}3d_offsetmode_info descriptor is described in the first loop 400 of the PMT, but the arib_{—}3d_offsetmode_info descriptor may be described in the second loop 402 of an ES information describing location 401.

In other words, the location for describing the arib_{—}3d_offsetmode_info descriptor, which describes information for identifying the display mode for 3D subtitles and the like, may be anywhere in the PMT that a descriptor can be described.

(8) Instead of describing the arib_{—}3d_offsetmode_info descriptor, a reserved area in the PMT may be used. In other words, it suffices for the mode identifying information to be described somewhere in the PMT. For example, two bits in a reserved area of the PMT may be used as the subtitle_offset_mode and the bml_offset_mode in FIG. 3 in order to describe the mode identifying information.

Alternatively, four bits among a reserved area may be used. Using four bits allows for describing of the mode identifying information as the subtitle_offset_mode and the bml_offset_mode in FIG. 10. When using four bits of a reserved area, the mode identifying information may be described by using one bit each for the subtitle_{—}1plane_offset_flag, the subtitle_{—}2plane_offset_flag, the bml_{—}1plane_offset_flag, and the bml_{—}2plane_offset_flag shown in FIG. 11. As the reserved area, any of reserved 403, reserved 404, and reserved 405 in FIG. 1, for example, may be used.

(9) While a reserved area in the PMT has been described as being used for describing the mode identifying information, use of an unused area is not limited to a reserved area in the PMT. A reserved area in a descriptor described in the PMT may be used. For example, by the same method as the above method for using a reserved area in the PMT, the mode identifying information may be described in a reserved area inside an existing descriptor described in the PMT.

(10) The above methods of describing information may be combined.

### 1.6 Supplementary Explanation

### Display Mode for 3D Subtitles and the Like

The 1 plane+offset mode and the 2 plane+offset mode, which are display modes for 3D subtitles and the like as determined in the present embodiment, are described with reference to the figures.

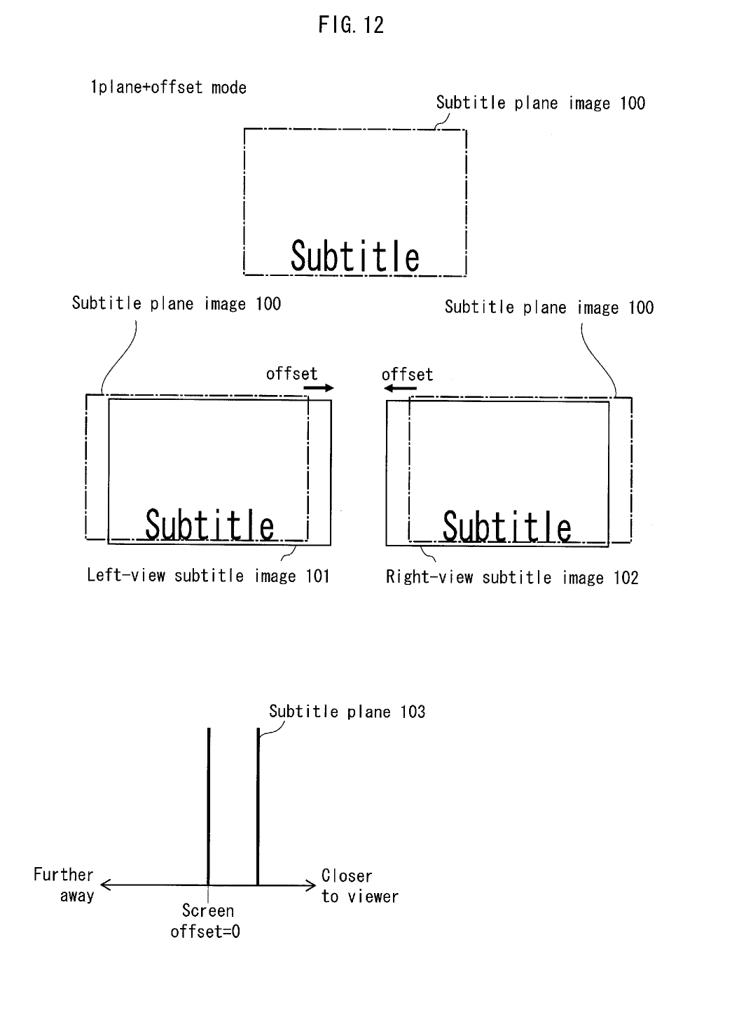

FIG. 12 conceptually shows the mechanism for 1 plane+offset mode.

After encoding, a subtitle plane image 100 is multiplexed and distributed as a subtitle display ES with ES's for other data, such as an ES for 3D video images and an audio ES.

The video processing device 300 decodes encoded subtitle data extracted from a received subtitle display ES, thus creating the subtitle plane image 100.

The video processing device 300 uses the subtitle plane image 100 and the offset value included in the ES for 3D video images to generate a left-view subtitle image and a right-view subtitle image for display of a 3D subtitle.

The offset value is represented as a number of pixels and is used for appropriately overlaying subtitles on a 3D video image. Since the subtitles need to be synchronized with video images, the offset value is transmitted in the ES for 3D video images. When the 3D video image data is encoded in MPEG format, the offset value is embedded as user data for a GOP (Group of Pictures) or for each video frame.

When outputting the left-view subtitle image to be overlaid on the left-view 3D video image, the video processing device 300 outputs a left-view subtitle image 101 yielded by shifting the created subtitle plane image 100 to the right by the number of pixels of the offset value. When outputting the right-view subtitle image to be overlaid on the right-view 3D video image, the video processing device 300 outputs a right-view subtitle image 102 yielded by shifting the created subtitle plane image 100 to the left by the number of pixels of the offset value. Due to the left-view subtitle image 101 and the right-view subtitle image 102, a subtitle plane 103 appears to be closer than the screen of the 3D video image.

Note that when the offset value is negative, the left-view subtitle image 101 is output after shifting the subtitle plane image 100 to the left, and the right-view subtitle image 102 is output after shifting the subtitle plane image 100 to the right. In this case, the subtitle plane 103 appears to be positioned behind the screen of the 3D video image.

The depth of the subtitle plane 103 can thus be set according to the offset value for shifting. 1 plane+offset mode allows for processing with one subtitle plane memory, and therefore processing in this display mode for 3D subtitles and the like has the advantage of requiring fewer decoders and memory than 2 plane+offset mode. Since a monoscopic image is positioned closer than the screen or behind the screen, however, 1 plane+offset mode has the disadvantage of not being able to show the objects themselves, such as the subtitle text, stereoscopically.

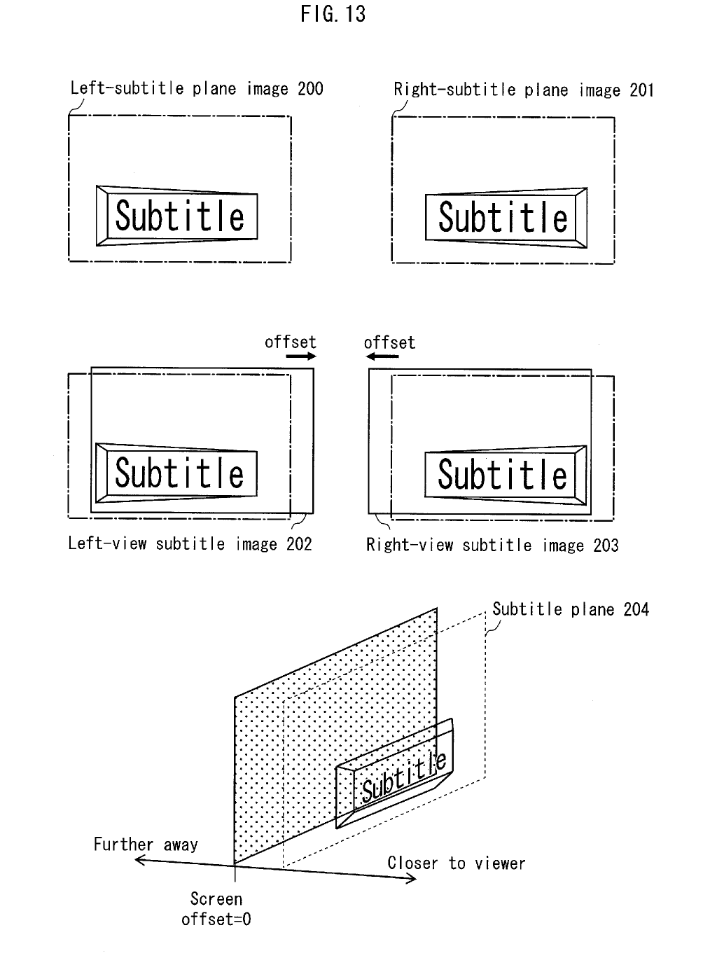

FIG. 13 conceptually shows the mechanism for 2 plane+offset mode. In 2 plane+offset mode, a subtitle is composed of two pieces of data: left-view subtitle data and right-view subtitle data. After encoding, these two pieces of subtitle data are multiplexed and distributed as separate ES's with ES's for other data, such as an ES for 3D video images and an audio ES.

The video processing device 300 receives and decodes the two subtitle ES's. First, a decoder reserved for left-view subtitle data decodes the left-view subtitle data to create a left-subtitle plane image 200. On the other hand, a decoder reserved for right-view subtitle data decodes the right-view subtitle data to create a right-subtitle plane image 201.

The video processing device 300 outputs a left-view subtitle image 202 yielded by shifting the created left-subtitle plane image 200 to the right by the number of pixels of the offset value included in the ES for 3D video images. The video processing device 300 outputs a right-view subtitle image 203 yielded by shifting the created right-subtitle plane image 201 to the left by the number of pixels of the offset value included in the ES for 3D video images. The left-view subtitle image 202 is overlaid on the left-view video image, and the right-view subtitle image 203 is overlaid on the right-view video images. As a result, a subtitle plane 204 appears to be positioned closer than the screen of the 3D video image. Note that when the offset value is negative, the left-view subtitle image 202 is created by shifting the left-subtitle plane image 200 to the left, and the right-view subtitle image 203 is created by shifting the right-subtitle plane image 201 to the right. In this case, the subtitle plane 204 appears to be positioned behind the screen of the 3D video image. The depth of the subtitle plane 204 can thus be set according to the offset value for shifting.

In 2 plane+offset mode, separate subtitle plane images are used for the left-view subtitle image and the right-view subtitle image. This allows for the subtitles themselves to be shown stereoscopically. Two decoders for the subtitles and two subtitle plane memories, however, are necessary. The 2 plane+offset mode thus has the disadvantage of a larger processing load for the video processing device 300 than the 1 plane+offset mode.

In the ARIB standard, subtitles and superimposed text can be displayed on the subtitle plane separately. Superimposed text can therefore also be displayed stereoscopically by the same processing as subtitles. Accordingly, the concept of subtitles in the present embodiment also includes superimposed text in the ARIB standard.

### Multiplexing Device 3000

Next, a multiplexing device for generating the multiplexed data stream received by the video processing device 300 of the present embodiment is described.

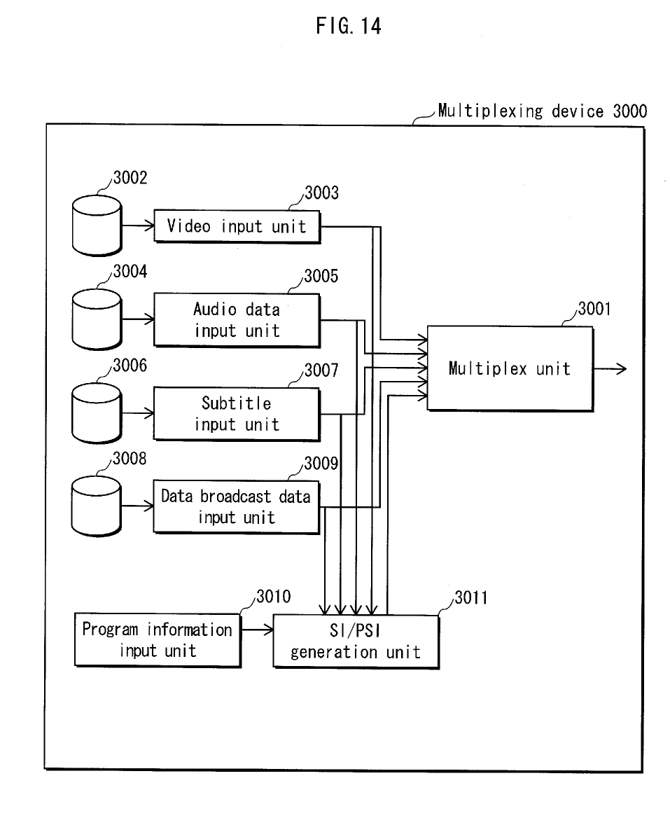

FIG. 14 is a structural diagram of a multiplexing device 3000 that generates a MPEG2-TS for broadcast or distribution.

The multiplexing device 3000 includes a multiplex unit 3001, a video data storage unit 3002, a video input unit 3003, an audio data storage unit 3004, an audio data input unit 3005, a subtitle data storage unit 3006, a subtitle input unit 3007, a data broadcast data storage unit 3008, a data broadcast data input unit 3009, a program information input unit 3010, and an SI/PSI generation unit 3011.

The multiplexing device 3000 includes a processor and a memory not shown in the figures. By the processor executing programs stored in the memory, the multiplexing device 3000 achieves the functions of the multiplex unit 3001, the video input unit 3003, the audio data input unit 3005, the subtitle input unit 3007, the data broadcast data input unit 3009, the program information input unit 3010, and the SI/PSI generation unit 3011.

The multiplex unit 3001 generates a TS stream from the video data, audio data, subtitle data, data broadcast data, and SI/PSI that are respectively output by the video input unit 3003, the audio data input unit 3005, the subtitle input unit 3007, the data broadcast data input unit 3009, and the SI/PSI generation unit 3011.

The video data storage unit 3002 is constituted by a storage medium such as a hard disk and stores video data.

The video input unit 3003 has a function to read the video data from the video data storage unit 3002, encode the video data, and output the result to the multiplex unit 3001, as well as a function to output, to the SI/PSI generation unit 3011, information regarding the video data as necessary for SI/PSI construction.

The audio data storage unit 3004 is constituted by a storage medium such as a hard disk and stores audio data.

The audio data input unit 3005 has a function to read the audio data from the audio data storage unit 3004, encode the audio data, and output the result to the multiplex unit 3001, as well as a function to output, to the SI/PSI generation unit 3011, information regarding the audio data as necessary for SI/PSI construction.

The subtitle data storage unit 3006 is constituted by a storage medium such as a hard disk and stores subtitle data.

The subtitle input unit 3007 has a function to read the subtitle data from the subtitle data storage unit 3006, encode the subtitle data, and output the result to the multiplex unit 3001, as well as a function to output, to the SI/PSI generation unit 3011, information regarding the subtitle data as necessary for SI/PSI construction. At this point, information on the display mode for 3D subtitles and the like in which the subtitle data is to be processed is also stored in the subtitle data storage unit 3006 along with the subtitle data. The subtitle input unit 3007 outputs this information on the display mode for 3D subtitles and the like to the SI/PSI generation unit 3011.

The data broadcast data storage unit 3008 is constituted by a storage medium such as a hard disk and stores data broadcast data.

The data broadcast data input unit 3009 has a function to read the data broadcast data from the data broadcast data storage unit 3008, encode the data broadcast data, and output the result to the multiplex unit 3001, as well as a function to output, to the SI/PSI generation unit 3011, information regarding the data broadcast data as necessary for SI/PSI construction. At this point, information on the display mode for 3D subtitles and the like in which the data broadcast data is to be processed is also stored in the data broadcast data storage unit 3008 along with the data broadcast data. The data broadcast data input unit 3009 outputs this information on the display mode for 3D subtitles and the like to the SI/PSI generation unit 3011.

The program information input unit 3010 outputs program structure information necessary for creation of an EIT to the SI/PSI generation unit 3011.

The SI/PSI generation unit 3011 generates the information of the SI/PSI based on the information input from the video input unit 3003, the audio data input unit 3005, the subtitle input unit 3007, the data broadcast data input unit 3009, and the program information input unit 3010, outputting the generated information of the SI/PSI to the multiplex unit 3001.

In accordance with the information on the display mode for 3D subtitles and the like obtained from the subtitle input unit 3007, the SI/PSI generation unit 3011 describes, in the first loop 400 of the PMT, an arib_{—}3d_offsetmode_info descriptor in which the subtitle_offset_mode is set to the value of the display mode for 3D subtitles and the like.

Also, in accordance with the information on the display mode for 3D subtitles and the like obtained from the data broadcast data input unit 3009, the SI/PSI generation unit 3011 describes, in the first loop 400 of the PMT, an arib_{—}3d_offsetmode_info descriptor in which the bml_offset_mode is set to the value of the display mode for 3D subtitles and the like.

### 1.7 Summary

The video processing device of the present embodiment determines the display mode for 3D subtitles and the like based on the mode identifying information described in the received PMT. The PMT is a data block to be processed before processing of the ES's that include the 3D video images and the display data for subtitles and the like. Therefore, before processing the display data for subtitles and the like, the video processing device can determine the display mode for 3D subtitles and the like and reserve resources. This shortens the time required before display data is displayed along with the 3D video images.

### Embodiment 2

### 2.1 Outline

In Embodiment 1, a newly defined arib_{—}3d_offsetmode_info descriptor is used. The present embodiment, on the other hand, differs by using the field of an already standardized descriptor, namely a data component descriptor (data_component_descriptor). The video processing device of the present embodiment determines the display mode for 3D subtitles and the like by extracting the mode identifying information not from the first loop 400 of the PMT, but rather from the data_component_id of the data component descriptor, which is described in the second loop 402.

As shown in FIG. 1, the second loop 402 is included in the ES information describing location 401. The ES information describing location 401 is a location for describing information for each ES pertaining to the program. Therefore, the number of iterations of the for loop in the ES information describing location 401 equals the number of ES's pertaining to the program.

The elementary_PID in FIG. 1 is information identifying the transport packets, which are the packets of the TS. The transport packets of the same video ES, the same subtitle ES, and the same SI/PSI table are respectively transmitted with the same elementary_PID attached thereto. Note that the elementary_PID is also simply referred to as a PID.

In the present embodiment, the mode identifying information for subtitles is described in the data component descriptor at the location for describing descriptors corresponding to the PID of the ES that includes the subtitle data. The mode identifying information for display data for a data broadcast is described in the data component descriptor at the location for describing descriptors corresponding to the PID of the ES that includes the display data for the data broadcast.

### 2.2 Data

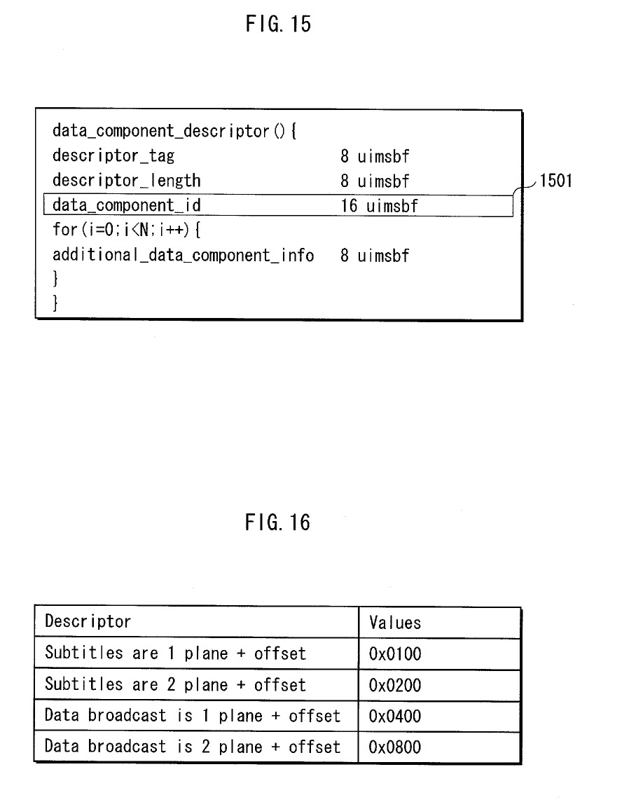

FIG. 15 shows the data structure of the data component descriptor.

A description of the fields in the data component descriptor can be found in the standards established by the ARIB and is therefore omitted here. Only the portion that is relevant to the present embodiment is described.

In the present embodiment, the mode identifying information is described in the data_component_id field within the data component descriptor. A data_component_id 1501 is 16 bits long.

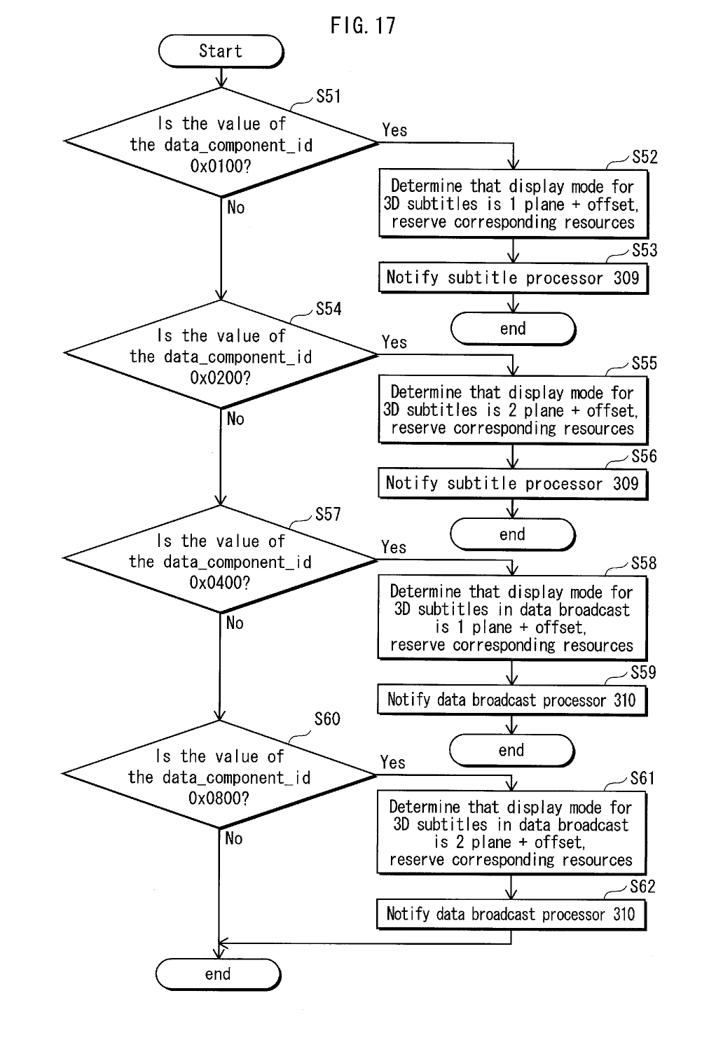

In the ARIB standard, the value of the conventional data_component_id that represents subtitles is 0x0008. In the present embodiment, however, the data_component_id takes the values shown in FIG. 16. As shown in FIG. 16, a value of 0x0100 is used for 3D subtitles processed in 1 plane+offset mode. A value of 0x0200 is used for 3D subtitles processed in 2 plane+offset mode. A value of 0x0400 is used for display data for a data broadcast processed in 1 plane+offset mode. A value of 0x0800 is used for display data for a data broadcast processed in 2 plane+offset mode.

### 2.3 Structure

A description of the structure of the video processing device in the present embodiment is omitted for components having the same structure as the video processing device 300 of Embodiment 1, with description focusing instead on the differences. Note that for the sake of convenience, the same reference numbers as in Embodiment 1 are used for the video processing device of the present embodiment.

One difference from Embodiment 1 is that the analysis unit 303 does not extract the mode identifying information from the arib_{—}3d_offsetmode_info described in the first loop of the PMT, but rather extracts the mode identifying information from the data_component_id in the data component descriptor described in the second loop 402, outputting the mode identifying information to the determination unit 304. Another difference is that the determination unit 304 does not determine the display mode for 3D subtitles and the like based on the mode identifying information described in the arib_{—}3d_offsetmode_info descriptor, but rather based on the value of the data_component_id of the data component descriptor.

### 2.4 Operations

Operations of the video processing device 300 of the present embodiment differ from Embodiment 1 in that, in step S15 of FIG. 7, instead of the arib_{—}3d_offsetmode_info descriptor in the first loop 400 of the PMT, the analysis unit 303 extracts the data component descriptor in the second loop 402 of the PMT and outputs the content thereof to the determination unit 304. Another difference is that in step S16, the determination unit 304 extracts the value of the data_component_id from the data component descriptor to determine the display mode for 3D subtitles and the like. Other steps are the same as in Embodiment 1, and therefore a description is omitted.

FIG. 17 is a flowchart showing details on the processing in step S16 by the determination unit 304 of the video processing device 300 of Embodiment 2.

The determination unit 304 extracts the data_component_id from the data component descriptor input from the analysis unit 303 and determines whether the value of the data_component_id equals 0x0100 (step S51). If the value of the data_component_id equals 0x0100 (step S51: Yes), the determination unit 304 determines that the display mode for 3D subtitles and the like in the subtitle processor 309 is 1 plane+offset mode and reserves the decoder and memory necessary for processing by the subtitle processor 309 (step S52). Next, the determination unit 304 notifies the subtitle processor 309 of the results of determination (step S53), thus completing the processing in step S16.

On the other hand, if the result of step S51 is “No”, the determination unit 304 determines whether the value of the data_component_id equals 0x0200 (step S54). If the value of the data_component_id equals 0x0200 (step S54: Yes), the determination unit 304 determines that the display mode for 3D subtitles and the like in the subtitle processor 309 is 2 plane+offset mode and reserves the decoders and memory necessary for processing by the subtitle processor 309 (step S55). Next, the determination unit 304 notifies the subtitle processor 309 of the results of determination (step S56), thus completing the processing in step S16.

If the result of step S54 is “No”, the determination unit 304 determines whether the value of the data_component_id equals 0x0400 (step S57). If the value of the data_component_id equals 0x0400 (step S57: Yes), the determination unit 304 determines that the display mode for 3D subtitles and the like in the data broadcast processor 310 is 1 plane+offset mode and reserves the decoder and memory necessary for processing by the data broadcast processor 310 (step S58). Next, the determination unit 304 notifies the data broadcast processor 310 of the results of determination (step S59), thus completing the processing in step S16.

Furthermore, if the result of step S57 is “No”, the determination unit 304 determines whether the value of the data_component_id equals 0x0800 (step S60). If the value of the data_component_id equals 0x0800 (step S60: Yes), the determination unit 304 determines that the display mode for 3D subtitles and the like in the data broadcast processor 310 is 2 plane+offset mode and reserves the decoders and memory necessary for processing by the data broadcast processor 310 (step S61). Next, the determination unit 304 notifies the data broadcast processor 310 of the results of determination (step S62), thus completing the processing in step S16.

Note that in the present embodiment, the display mode for 3D subtitles and the like is determined based on the mode identifying information described in the data component descriptor, which is described in the second loop of the PMT. Since the data component descriptor is included in information within the PMT regarding the ES's constituting a program, the determination unit 304 may determine, before the processing in step S51, whether the data component descriptor is part of a description of information regarding an ES that includes subtitle data, or a part of a description of information regarding an ES that includes display data for a data broadcast. In the case of information regarding an ES that includes subtitle data, processing then proceeds to step S51, whereas in the case of information regarding an ES that includes display data for a data broadcast, processing proceeds to step S57.

### 2.5 Modifications to Embodiment 2

(1) The values taken by the mode identifying information in the data_component_id have been described as the values shown in FIG. 16, but the values taken by the mode identifying information are not limited to these values. Any values may be used, as long as the values can be expressed with the bit length allocated to the data_component_id and allow for identification of the processing modes.

### 2.6 Supplementary Explanation

The SI/PSI generation unit 3011 of the multiplexing device 3000 defines the value of the data_component_id in the loop with the information on the ES with subtitles within the second loop 402 in the PMT, to indicate the mode identifying information according to the information output by the subtitle input unit 3007. The SI/PSI generation unit 3011 also defines the value of the data_component_id in the loop with the information on the ES with display data for a data broadcast within the second loop 402 in the PMT, to indicate mode identifying information according to the information output by the data broadcast data input unit 3009.

### 2.7 Summary

The video processing device of the present embodiment uses the field of an existing descriptor to describe the mode identifying information. This allows for identification of the display mode for 3D subtitles and the like without the definition of a new descriptor, as in Embodiment 1, and without extending the fields of an existing descriptor.

### Embodiment 3

### 3.1 Outline

In Embodiment 2, the mode identifying information is described in the data_component_id of the data component descriptor (data_component_descriptor), which is an already standardized descriptor described in the second loop 402 of the PMT. The present embodiment differs from Embodiment 2 in that the mode identifying information is described in a reserved area in the data component descriptor.

The video processing device of the present embodiment determines the display mode for 3D subtitles and the like by extracting the mode identifying information not from the first loop 400 of the PMT, but rather from a reserved area of the data component descriptor, which is described in the second loop 402.

### 3.2 Data

The following describes the data structure of data in the present embodiment.

The present embodiment uses the additional_arib_bxml_info descriptor, which is described in the data component descriptor shown in FIG. 15 as a piece of additional_data_component_info.

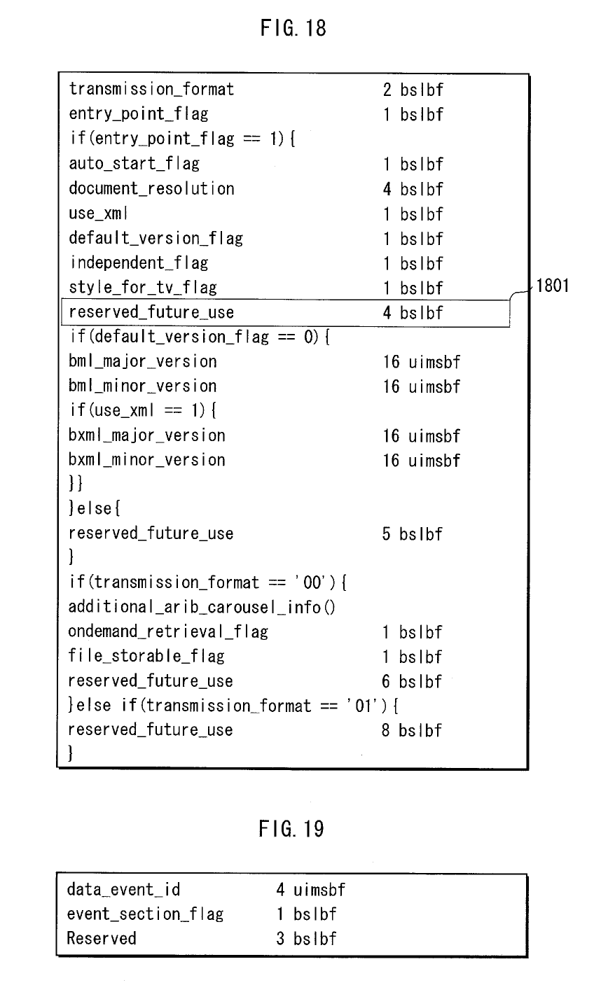

FIG. 18 shows the data structure of the additional_arib_bxml_info.

In the present embodiment, the two least significant bits of the four-bit reserved_future_use 1801 are used to describe the subtitle_offset_mode and the bml_offset_mode of FIG. 3. The values that can be taken by the subtitle_offset_mode and the bml_offset_mode are the same as in Embodiment 1, and therefore a description thereof is omitted.

### 3.3 Structure

A description of the structure of the video processing device in the present embodiment is omitted for components having the same structure as the video processing device 300 of Embodiment 1, with description focusing instead on the differences. Note that for the sake of convenience, the same reference numbers as in Embodiment 1 are used for the video processing device of the present embodiment.

One difference from Embodiment 1 is that the analysis unit 303 does not extract the mode identifying information from the arib_{—}3d_offsetmode_info described in the first loop of the PMT, but rather extracts the mode identifying information from a reserved area in the data component descriptor, outputting the mode identifying information to the determination unit 304. Another difference is that the determination unit 304 determines the display mode for 3D subtitles and the like based on this mode identifying information.

### 3.4 Operations

Operations of the video processing device 300 in the present embodiment differ from Embodiment 2 in that, in step S15 of FIG. 7, instead of the arib_{—}3d_offsetmode_info descriptor in the first loop 400 of the PMT, the analysis unit 303 extracts the data component descriptor in the second loop 402 of the PMT and outputs the content thereof to the determination unit 304. Another difference is that in step S16, the determination unit 304 extracts the value of the two least significant bits of the reserved_future_use 1801 and determines the display mode for 3D subtitles and the like based on this value. Other steps are the same as in Embodiment 2, and therefore a description is omitted.

In step S16, if the value of the two least significant bits of the reserved_future_use 1801 is “00”, the determination unit 304 determines that the mode is 1 plane+offset mode for both subtitles and for display data for a data broadcast. If the value is “01”, the determination unit 304 determines that the mode is 1 plane+offset mode for subtitles and 2 plane+offset mode for display data for a data broadcast. If the value is “10”, the determination unit 304 determines that the mode is 2 plane+offset mode for subtitles and 1 plane+offset mode for display data for a data broadcast, and if the value is “11”, the determination unit 304 determines that the mode is 2 plane+offset mode for both subtitles and for display data for a data broadcast.

### 3.5 Modifications to Embodiment 3

(1) In the present embodiment, the mode identifying information is described in the two least significant bits of the reserved_future_use 1801, but the location of description of the mode identifying information is not limited to the two least significant bits of the reserved_future_use 1801. It suffices to reserve any two bits for the mode identifying information. For example, the mode identifying information may be described in the two most significant bits of the reserved_future_use 1801.

(2) Furthermore, while the reserved_future_use 1801 is used in the present embodiment, the reserved area that is used is not limited to the reserved_future_use 1801. Any reserved area in the data component descriptor may be used. For example, the additional_arib_bxml_info within the data component descriptor includes an additional_arib_carousel_info descriptor, a reserved area of which may be used for describing information. Information may also be described in two bits of the “Reserved” portion of the data structure of the additional_arib_carousel_info shown in FIG. 19.

(3) In the present embodiment, the values of the subtitle_offset_mode and the bml_offset_mode shown in FIG. 3 are described as the mode identifying information, but the mode identifying information is not limited to taking these values. Any information that allows for identification of the display mode for 3D subtitles and the like may be used. For example, the values of the subtitle_offset_mode and the bml_offset_mode shown in FIG. 10 may be described using four bits of the reserved_future_use 1801.

Alternatively, four bits of the reserved_future_use 1801 may be used to describe the value of the subtitle_{—}1plane_offset_flag, the subtitle_{—}2plane_offset_flag, the bml_{—}1plane_offset_flag, and the bml_{—}2plane_offset_flag shown in FIG. 11.

### 3.6 Summary

The video processing device of the present embodiment uses a reserved area of an existing descriptor to describe the mode identifying information. This allows for identification of the display mode for 3D subtitles and the like without the definition of a new descriptor, as in Embodiment 1, and without extending the fields of a descriptor.

### Embodiment 4

### 4.1 Outline

In Embodiment 1, the arib_{—}3d_offsetmode_info descriptor is described in the PMT, which is one of PSI information. Embodiment 4 differs from Embodiment 1, however, by describing the arib_{—}3d_offsetmode_info descriptor in the EIT, which is one of SI information, rather than in the PMT. The video processing device of the present embodiment makes a determination by extracting the mode identifying information included in a descriptor described in the EIT.

### 4.2 Data

The following describes the data structure of the EIT used in the present embodiment.

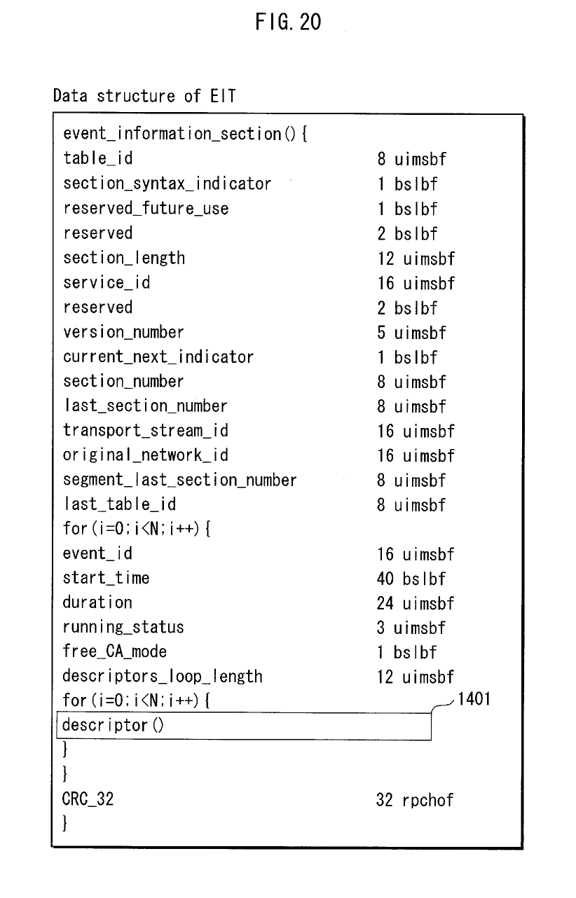

FIG. 20 shows the data structure of the EIT.

The EIT stores information on the program such as the name, broadcast time, and content of the program. A description of individual fields can be found in the standards established by the ARIB and is therefore omitted here. Only the portion that is relevant to the present embodiment is described.

In the EIT, the arib_{—}3d_offsetmode_info descriptor is described in the descriptor 1401 within a for loop. Note that this descriptor 1401 describes information that differs for each program described in the EIT.

The arib_{—}3d_offsetmode_info descriptor is the same as in Embodiment 1, and therefore a description thereof is omitted.

While the PMT is transmitted along with data constituting each program, the EIT is transmitted ahead of a program and is used to construct an EPG (Electronic Program Guide). The EIT is also used for scheduling of recording or viewing.

### 4.3 Structure

A description of the structure of the video processing device in the present embodiment is omitted for components having the same structure as the video processing device 300 of Embodiment 1, with description focusing instead on the differences. Note that for the sake of convenience, the same reference numbers as in Embodiment 1 are used for the video processing device of the present embodiment.

The analysis unit 303 differs from Embodiment 1 by determining the display mode for 3D subtitles and the like based on the mode identifying information included in the EIT rather than in the PMT.

### 4.4 Operations

Operations of the video processing device 300 are described for an example in which the user has scheduled viewing of one program among a plurality of programs included in the EIT.

When the starting time of the program scheduled for viewing is reached, the reception unit 301 in the video processing device 300 receives stream data for the scheduled program. In step S15 of FIG. 7, the analysis unit 303 extracts the arib_{—}3d_offsetmode_info descriptor from among information that pertains to the program scheduled for viewing and is included in the EIT received in advance, outputting the extracted descriptor to the determination unit 304.

Subsequent processing is the same as in Embodiment 1, and therefore a description is omitted.

### 4.5 Modifications to Embodiment 4

(1) In the present embodiment, the mode identifying information is extracted from the EIT at the program start time, but processing to extract the mode identifying information from the EIT is not limited to the program start time. Since the EIT is received before the start of programs, the display mode of 3D subtitles and the like of each program for which information is described in the EIT may be determined and stored before the start of each program. For example, upon receipt of the EIT, the content of the arib_{—}3d_offsetmode_info descriptors included in the EIT may be extracted and saved, and at the program start time, the determination unit 304 may determine the display mode for 3D subtitles and the like based on the saved content. Alternatively, a determination may be made in advance and the results of the determination stored. The results of the determination would then be read at the start of the program before performing subsequent processing.

(2) In the present embodiment, the arib_{—}3d_offsetmode_info descriptor is newly defined and described in the EIT, but a new descriptor need not be defined. It suffices for the mode identifying information to be described in the EIT. For example, instead of describing the arib_{—}3d_offsetmode_info descriptor, a reserved area in the EIT may be used.

Specifically, the display mode for 3D subtitles and the like may be determined based on a description of the value of the subtitle_offset_mode and the bml_offset_mode shown in FIG. 3 in any two bits of a reserved area in the EIT.

(3) Note that use of a reserved area is not limited to two bits. The bits necessary for describing the mode identifying information may be allocated. For example, the display mode for 3D subtitles and the like may be determined based on a description of the value of the subtitle_offset_mode and the bml_offset_mode shown in FIG. 12 in any four bits of a reserved area.

(4) When using four bits of a reserved area, the value of the subtitle_{—}1plane_offset_flag, the subtitle_{—}2plane_offset_flag, the bml_{—}1plane_offset_flag, and the bml_{—}2plane_offset_flag shown in FIG. 11 may be described and used to determine the display mode for 3D subtitles and the like.

(5) The above methods of describing the mode identifying information may be combined.

(6) Since the EIT is distributed to the video processing device before broadcast or distribution of the program, content that is actually broadcast may differ from the information distributed in the EIT, due to an emergency broadcast or the like. As a result, processing may be combined with the identification method using the PMT as described in Embodiment 1.

### 4.6 Supplementary Explanation

The SI/PSI generation unit 3011 of the multiplexing device 3000 generates the EIT based on the program structure information input from the program information input unit 3010. At this point, the program information input unit 3010 outputs the display mode for 3D subtitles and the like for the subtitles in each program and the display mode for 3D subtitles and the like for display data for a data broadcast to the SI/PSI generation unit 3011. Based on the information output by the program information input unit 3010, the SI/PSI generation unit 3011 sets the mode identifying information in the location for describing information on each program in the EIT.

### 4.7 Summary

The video processing device of the present embodiment determines the display mode for 3D subtitles and the like based on the mode identifying information for each program described in the received EIT.

Since the EIT is transmitted before a program is broadcast, the display mode for 3D subtitles and the like can be determined and resources reserved before processing of the display data for subtitles and the like for the program. This shortens the time required before display data is displayed along with the 3D video images.

### Embodiment 5

### 5.1 Outline

In Embodiment 4, mode identifying information is described in the arib_{—}3d_offsetmode_info descriptor, which is a newly defined descriptor, at a location for describing information on programs in the EIT. The video processing device extracts this mode identifying information to determine the display mode for 3D subtitles and the like. In the present embodiment, on the other hand, the mode identifying information is described in a data content descriptor (data content descriptor), which is an existing standardized descriptor, and the display mode for 3D subtitles and the like is determined by extracting this mode identifying information.

### 5.2 Data

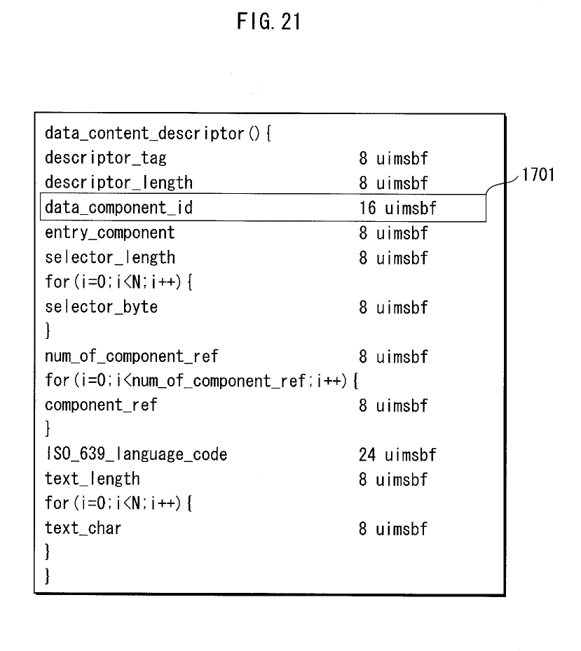

FIG. 21 shows the data structure of the data content descriptor.

A description of the fields in the data content descriptor can be found in the standards established by the ARIB and is therefore omitted here. Only the portion that is relevant to the present embodiment is described.

In the present embodiment, the mode identifying information is described in a data_component_id 1701 within the data content descriptor.

The values for identifying the display mode for 3D subtitles and the like for subtitles and for display data for a data broadcast are as in FIG. 16.

The EIT is not information on the individual ES's of a program, but rather describes information shared by the ES's of a program. Therefore, the data_component_id 1701 needs to allow for identification of the display mode for 3D subtitles and the like both for subtitles and for display data for a data broadcast. A description of the values of the data_component_id can be found above and is therefore omitted here.

In order to allow for identification of the display mode for 3D subtitles and the like both for subtitles and for display data for a data broadcast, the sum of the values is used. Specifically, if subtitles are to be processed in 2 plane+offset mode, for example, and display data for a data broadcast is to be processed in 1 plane+offset mode, the sum of 0x0200 and 0x0400, i.e. 0x0600, is used. If subtitles and display data for a data broadcast are both to be processed in 2 plane+offset mode, the sum of 0x0200 and 0x0800, i.e. 0x0A00, is used. The sum of other combinations is similarly used.

### 5.3 Structure

A description of the structure of the video processing device in the present embodiment is omitted for components having the same structure as the video processing device 300 of Embodiment 4, with description focusing instead on the differences. Note that for the sake of convenience, the same reference numbers as in Embodiment 4 are used for the video processing device of the present embodiment.

One difference from Embodiment 4 is that the analysis unit 303 does not extract the mode identifying information from the arib_{—}3d_offsetmode_info in the EIT, but rather extracts the mode identifying information from the data_component_id in the data content descriptor, outputting the mode identifying information to the determination unit 304. Another difference is that the determination unit 304 determines the display mode for 3D subtitles and the like based on the value of the data_component_id.

### 5.4 Operations

Operations of the video processing device 300 in the present embodiment differ from Embodiment 4 in that, in step S15 of FIG. 7, the analysis unit 303 extracts the data content descriptor and outputs the data content descriptor to the determination unit 304. Another difference is that in step S16, the determination unit 304 extracts the value of the data_component_id from the data content descriptor and determines the display mode for 3D subtitles and the like based on the extracted value. Other steps are the same as in Embodiment 4, and therefore a description is omitted.

The following describes details on the processing in step S16 of the present embodiment.

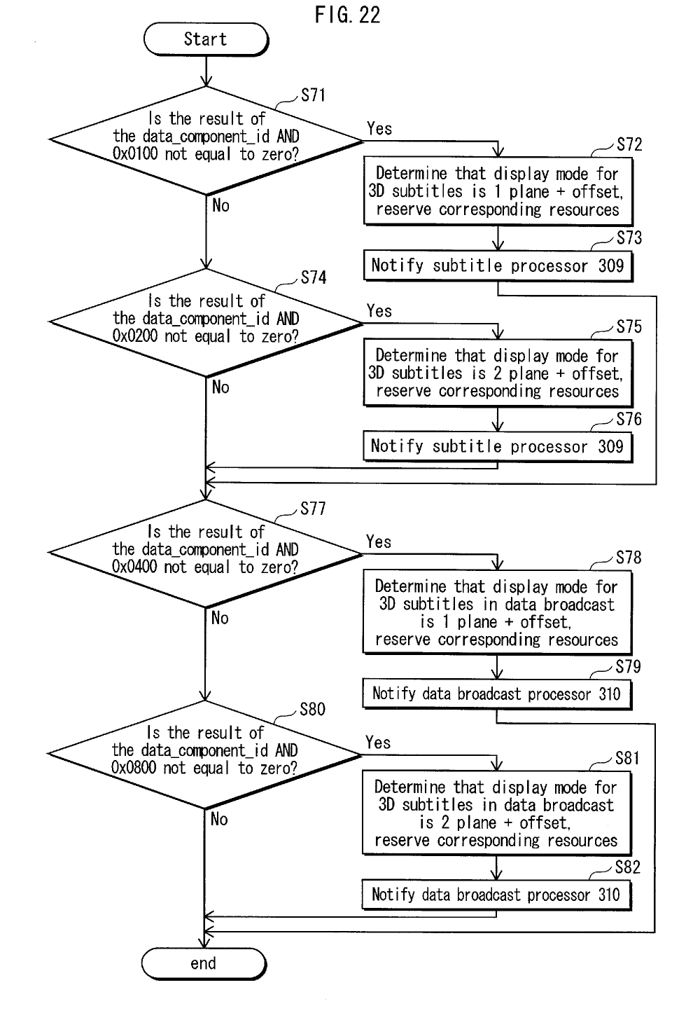

FIG. 22 is a flowchart showing details on the processing in step S16 by the determination unit 304 of the video processing device 300 of the present embodiment.

The determination unit 304 extracts the data_component_id from the data content descriptor input from the analysis unit 303, performs an AND operation on the value of the data_component_id and 0x0100. The determination unit then determines whether the result is “0” (step S71). If the result of the AND operation is not “0” (step S71: Yes), the determination unit 304 determines that the display mode for 3D subtitles and the like in the subtitle processor 309 is 1 plane+offset mode and reserves the decoder and memory necessary for processing by the subtitle processor 309 (step S72). Next, the determination unit 304 notifies the subtitle processor 309 of the results of determination (step S73), and processing proceeds to step S77.

On the other hand, if the result of step S71 is “No”, the determination unit 304 performs an AND operation on the value of the data_component_id and 0x0200. The determination unit 304 then determines whether the result is “0” (step S74). If the result of the AND operation is not “0” (step S74: Yes), the determination unit 304 determines that the display mode for 3D subtitles and the like in the subtitle processor 309 is 2 plane+offset mode and reserves the decoders and memory necessary for processing by the subtitle processor 309 (step S75). Next, the determination unit 304 notifies the subtitle processor 309 of the results of determination (step S76), and processing proceeds to step S77.

If the result of step S74 is “No”, the determination unit 304 performs an AND operation on the value of the data_component_id and 0x0400. The determination unit then determines whether the result is “0” (step S77). If the result of the AND operation is not “0” (step S77: Yes), the determination unit 304 determines that the display mode for 3D subtitles and the like in the data broadcast processor 310 is 1 plane+offset mode and reserves the decoder and memory necessary for processing by the data broadcast processor 310 (step S78). Next, the determination unit 304 notifies the data broadcast processor 310 of the results of determination (step S79), thus completing the processing in step S16.

If the result of step S77 is “No”, the determination unit 304 performs an AND operation on the value of the data_component_id and 0x0800. The determination unit then determines whether the result is “0” (step S80). If the result of the AND operation is not “0” (step S80: Yes), the determination unit 304 determines that the display mode for 3D subtitles and the like in the data broadcast processor 310 is 2 plane+offset mode and reserves the decoders and memory necessary for processing by the data broadcast processor 310 (step S81). Next, the determination unit 304 notifies the data broadcast processor 310 of the results of determination (step S82), thus completing the processing in step S16.

### 5.5 Modifications to Embodiment 5

(1) The values taken by the mode identifying information in the data_component_id have been described as the values shown in FIG. 16, but the values taken by the mode identifying information are not limited to these values. Any values may be used, as long as the values can be expressed with the bit length allocated to the data_component_id and allow for identification of the display mode for 3D subtitles and the like for both subtitles and display data for a data broadcast.

### 5.6 Summary

The video processing device of the present embodiment uses the field of an existing descriptor to describe the mode identifying information. This allows for identification of the display mode for 3D subtitles and the like without the definition of a new descriptor, as in Embodiment 4, and without extending the fields of a descriptor.

### Embodiment 6

### 6.1 Outline

In Embodiment 5, mode identifying information is described in the data_component_id of the data content descriptor, which is a standardized existing descriptor, and the mode identifying information is extracted to determine the display mode for 3D subtitles and the like. In the present embodiment, on the other hand, the mode identifying information is described in a field defined as a reserved area of the data content descriptor, and the display mode for 3D subtitles and the like is determined by extracting this mode identifying information.

### 6.2 Data

The following describes the data structure of data in the present embodiment.

The present embodiment uses an arib_bxml_info descriptor described as one selector byte in the selector byte sequence in the data content descriptor shown in FIG. 21.

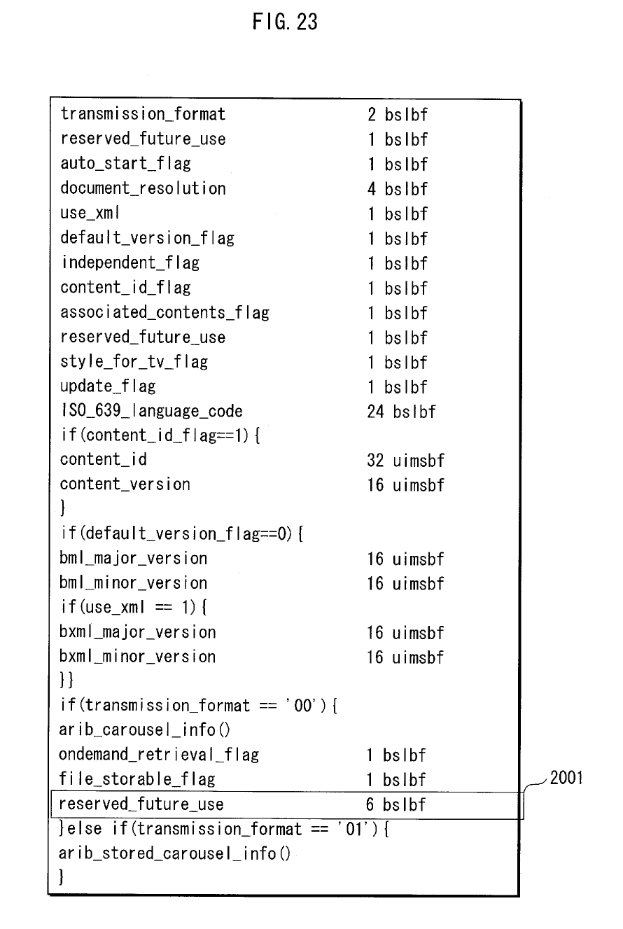

FIG. 23 shows the data structure of the arib_bxml_info descriptor.

In the present embodiment, the two least significant bits of the six-bit reserved_future_use 2001 in the arib_bxml_info descriptor are used to describe the subtitle_offset_mode and the bml_offset_mode of FIG. 3. The values that can be taken by the subtitle_offset_mode and the bml_offset_mode are the same as in Embodiment 1, and therefore a description thereof is omitted.

### 6.3 Structure

A description of the structure of the video processing device in the present embodiment is omitted for components having the same structure as the video processing device 300 of Embodiment 5, with description focusing instead on the differences. Note that for the sake of convenience, the same reference numbers as in Embodiment 5 are used for the video processing device of the present embodiment.

One difference from Embodiment 5 is that the analysis unit 303 does not extract the mode identifying information from the data_component_id in the data content descriptor, but rather extracts the mode identifying information from a reserved area in the data content descriptor, outputting the mode identifying information to the determination unit 304. Another difference is that the determination unit 304 determines the display mode for 3D subtitles and the like based on this mode identifying information.

### 6.4 Operations

Operations of the video processing device 300 in the present embodiment differ from Embodiment 5 in that, in step S16 of FIG. 7, the determination unit 304 extracts the value of the two least significant bits of the reserved_future_use 2001 from the data content descriptor and determines the display mode for 3D subtitles and the like based on the extracted value. Other steps are the same as in Embodiment 5, and therefore a description is omitted.

In step S16, if the value of the two least significant bits of the reserved_future_use 2001 is “00”, the determination unit 304 determines that the mode is 1 plane+offset mode for both subtitles and for display data for a data broadcast. If the value is “01”, the determination unit 304 determines that the mode is 1 plane+offset mode for subtitles and 2 plane+offset mode for display data for a data broadcast. If the value is “10”, the determination unit 304 determines that the mode is 2 plane+offset mode for subtitles and 1 plane+offset mode for display data for a data broadcast, and if the value is “11”, the determination unit 304 determines that the mode is 2 plane+offset mode for both subtitles and for display data for a data broadcast.

### 6.5 Modifications to Embodiment 6

(1) In the present embodiment, the mode identifying information is described in the two least significant bits of the reserved_future_use 2001, but the location of the descrition of the mode identifying information is not limited to the two least significant bits of the reserved_future_use 2001. It suffices to reserve any two bits for the mode identifying information. For example, the mode identifying information may be described in the two most significant bits of the reserved_future_use 2001.

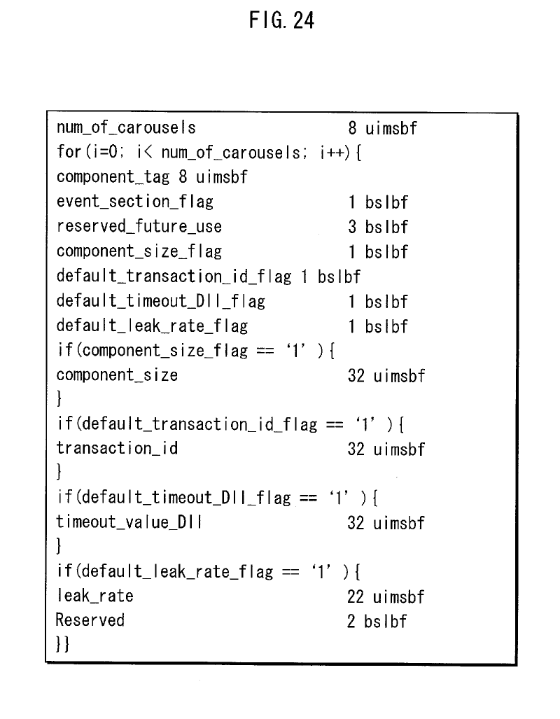

(2) Furthermore, the mode identifying information is not limited to being described in the reserved_future_use 2001. Any reserved area of the data content descriptor may be used. For example, the arib_bxml_info descriptor in FIG. 23 includes an arib_carousel_info descriptor, a reserved area of which may be used for describing. Specifically, the mode identifying information may be described in the two bits of “Reserved” in the arib_carousel_info shown in FIG. 24.

(3) In the present embodiment, the values of the subtitle_offset_mode and the bml_offset_mode shown in FIG. 3 are described as the mode identifying information, but the mode identifying information is not limited to taking these values. Any information that allows for identification of the display mode for 3D subtitles and the like may be used. For example, the values of the subtitle_offset_mode and the bml_offset_mode shown in FIG. 10 may be described in four bits of the reserved_future_use 2001.

(4) The value of the subtitle_{—}1plane_offset_flag, the subtitle_{—}2plane_offset_flag, the bml_{—}1plane_offset_flag, and the bml_{—}2plane_offset_flag shown in FIG. 11 may be described in four bits of the reserved_future_use 2001.

(5) The above methods of describing the mode identifying information may be combined.

### 6.6 Summary

The video processing device of the present embodiment describes the mode identifying information using a reserved area of an existing descriptor, thus allowing for identification of the display mode for 3D subtitles and the like without extending the fields of a descriptor.

### Embodiment 7

### 7.1 Outline

In Embodiment 7, the mode identifying information is described in metadata of content that is distributed not by broadcast but rather by VOD (Video On Demand) service in an electronic video distribution system that uses an IP (Internet Protocol) network. The video processing device analyzes the metadata to determine the display mode for 3D subtitles and the like.

### 7.2 Data

The electronic video distribution system of the present embodiment describes the mode identifying information in the playback control information defined by the “Digital TV Network functionality Specification Streaming Specification, Codec Section” of the Digital Television Information Study Group. The present embodiment illustrates an example of describing the mode identifying information in the ERI (Entry Resource Information).

The following describes the data used in the present embodiment.

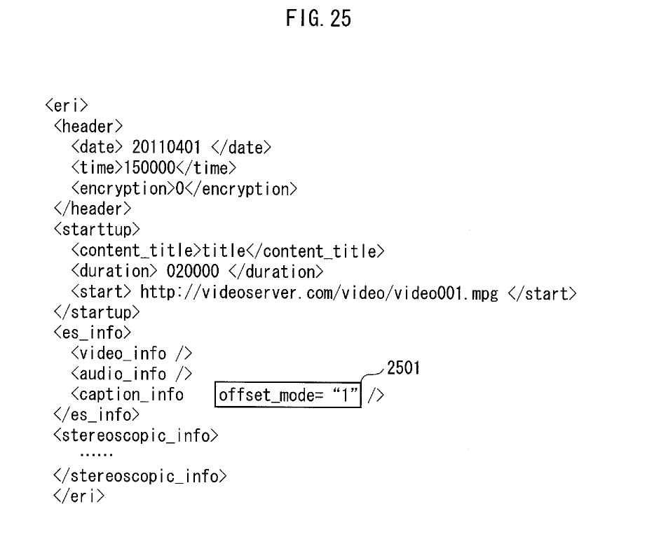

FIG. 25 shows the data structure of the ERI. Description that is not necessary for the present embodiment is omitted. The ERI is described in XML (Extensible Markup Language) document format.

A caption_info tag, which can appear from zero to two times in one ERI, may be described as a tag describing information on subtitles in the ERI.

In the present embodiment, a new attribute is added to the caption_info tag, an offset mode 2501. A non-existent offset mode 2501, or a value of “0” for the offset_mode 2501, is defined as indicating that subtitles are not 3D, but rather are conventional 2D subtitles. A value of “1” for the offset_mode 2501 indicates 1 plane+offset mode, whereas a value of “2” indicates 2 plane+offset mode.

### 7.3 Structure

A description of the structure of the video processing device in the present embodiment is omitted for components having the same structure as the video processing device 300 of Embodiment 1, with description focusing instead on the differences. Note that for the sake of convenience, the same reference numbers as in Embodiment 1 are used for the video processing device of the present embodiment.

One difference from Embodiment 1 is that the reception unit 301 does not receive a broadcast, but rather information over an IP network, the information being composed of content data, such as video and audio, that constitutes a program and is transmitted in MPEG2-TS format, as well as data transmitted in a format other than MPEG2-TS, for example a content list and metadata such as playback control information. Another difference is that the determination unit 304 does not receive the PMT from the analysis unit 303, but rather receives the ERI from the reception unit 301 as the received playback control information. Yet another difference is that the determination unit 304 determines the display mode for 3D subtitles and the like based on the mode identifying information described not in the arib_{—}3d_offsetmode_info descriptor, but rather in the tag defined in the ERI.

### 7.4 Operations

First of all, the operations of the video processing device 300 in the present embodiment differ from Embodiment 1 by omitting the processing in step S18 of FIG. 7, and in that the processing in steps S16 and S17 is performed when the ERI is received, i.e. before processing in FIG. 7 other than steps S16, S17, and S18 to receive content data and to play back the content data. Another difference is that in step S16, the determination unit 304 determines the display mode for 3D subtitles and the like based on the value of the caption_info tag extracted from the ERI. Other steps are the same as in Embodiment 1, and therefore a description is omitted.

In step S16, if the value of the offset_mode 2501 is “1”, the determination unit 304 determines that the display mode for 3D subtitles and the like in the subtitle processor 309 is 1 plane+offset mode, whereas if the value is “2”, the determination unit 304 determines that the display mode for 3D subtitles and the like is 2 plane+offset mode.

### 7.5 Modifications to Embodiment 7

(1) In the present embodiment, the value of the mode identifying information is either “0” or “1”, but the values used for identification are not limited to these. Any value that allows for identification of the display mode for 3D subtitles and the like may be used. For example, for 1 plane+offset mode, a value of “1 plane+offset mode” may be used, and for 2 plane+offset mode, a value of “2 plane+offset mode” may be used.

(2) The present embodiment represents the display mode for 3D subtitles and the like by adding an attribute to the caption_info tag of the ERI. Alternatively, a sub-tag may be added to the caption_info tag, and the mode identifying information may be described in the sub-tag.

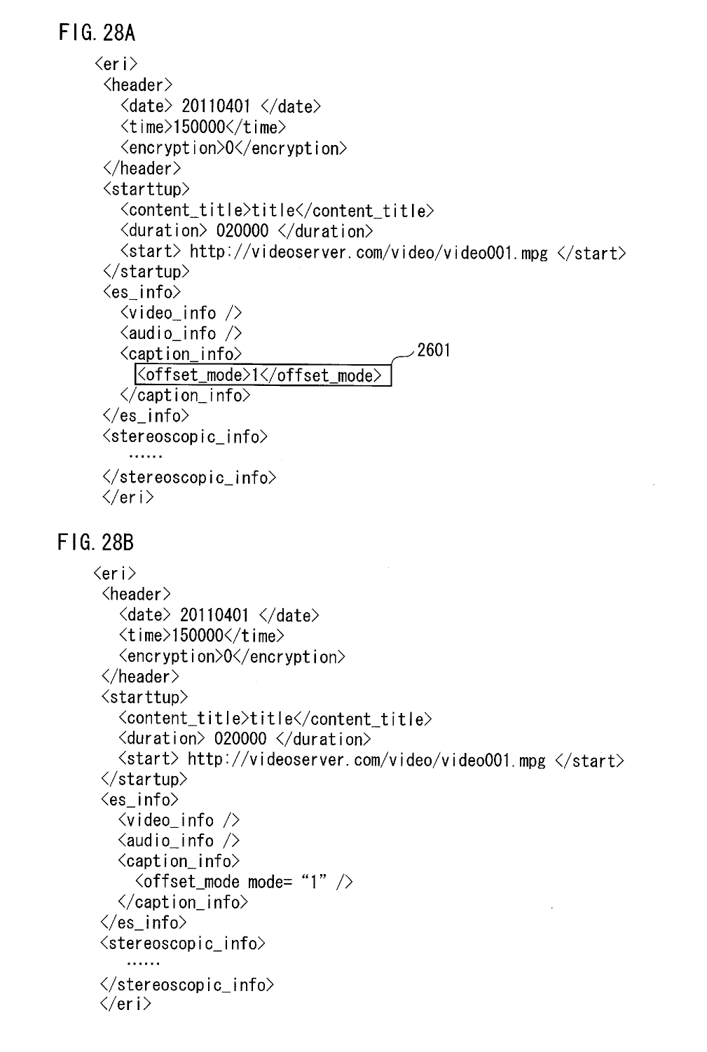

Specifically, an offset_mode tag may be added as a sub-tag to the caption_info tag, as shown in FIG. 28A. A value of “0” for the offset_mode tag may be defined as indicating display with conventional 2D subtitles, a value of “1” as indicating 1 plane+offset mode, and a value of “2” as indicating 2 plane+offset mode. These values may be used to determine the display mode for 3D subtitles and the like. Note that instead of setting the value of the offset_mode tag to “0” in the case of displaying conventional 2D subtitles, the offset_mode tag may be omitted from the caption_info tag. Absence of the offset_mode tag may then be determined as indicating display of conventional 2D subtitles.

(3) As shown in FIG. 28B, the offset_mode tag may be an empty tag with no content. A mode may be defined as an attribute of the offset_mode. A non-existent offset_mode, or a value of “0” for the mode attribute, may be defined as indicating that subtitles are not 3D, but rather are conventional 2D subtitles. A value of “1” for the mode attribute may be defined as indicating 1 plane+offset mode, whereas a value of “2” may be defined as indicating 2 plane+offset mode.

(4) In the present embodiment, the mode identifying information is described in an attribute or a sub-tag that is added to the caption_info tag of the ERI. A tag other than the caption_info tag may, however, be used. Any tag within the ERI may be used. When using a tag other than the caption_info tag, the same method as for the caption_info tag may be used. For example, the stereoscopic info tag may be used to determine the display mode for 3D subtitles and the like by defining the stereoscopic info tag in the same way as the caption_info tag.

### 7.6 Supplementary Explanation

The following describes an electronic video distribution system 2200 according to the present embodiment.

### 7.6.1 Structure

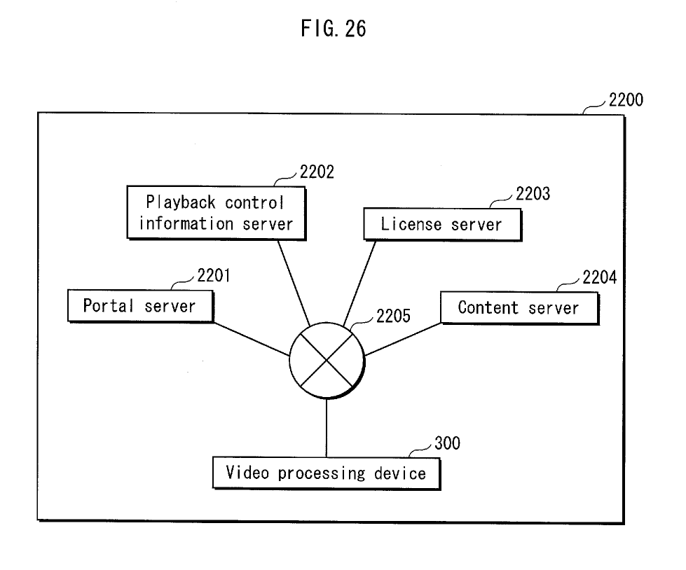

FIG. 26 is a structural diagram of the electronic video distribution system 2200 according to the present embodiment.

The electronic video distribution system 2200 includes the video processing device 300, a portal server 2201, a playback control information server 2202, a license server 2203, and a content server 2204. These servers and the video processing device 300 are connected by an IP network 2205.

The portal server 2201 provides a list of content distributable to the video processing device 300, as well as the URL (Uniform Resource Locator) of the metadata necessary for playback of a content.

The playback control information server 2202 provides metadata for content. The ERI is provided by this server.

The license server 2203 provides the video processing device 300 with a license to use content that the video processing device 300 receives and plays back.

The content server 2204 provides the video processing device 300 with content data such as video.

### 7.6.2 Operations

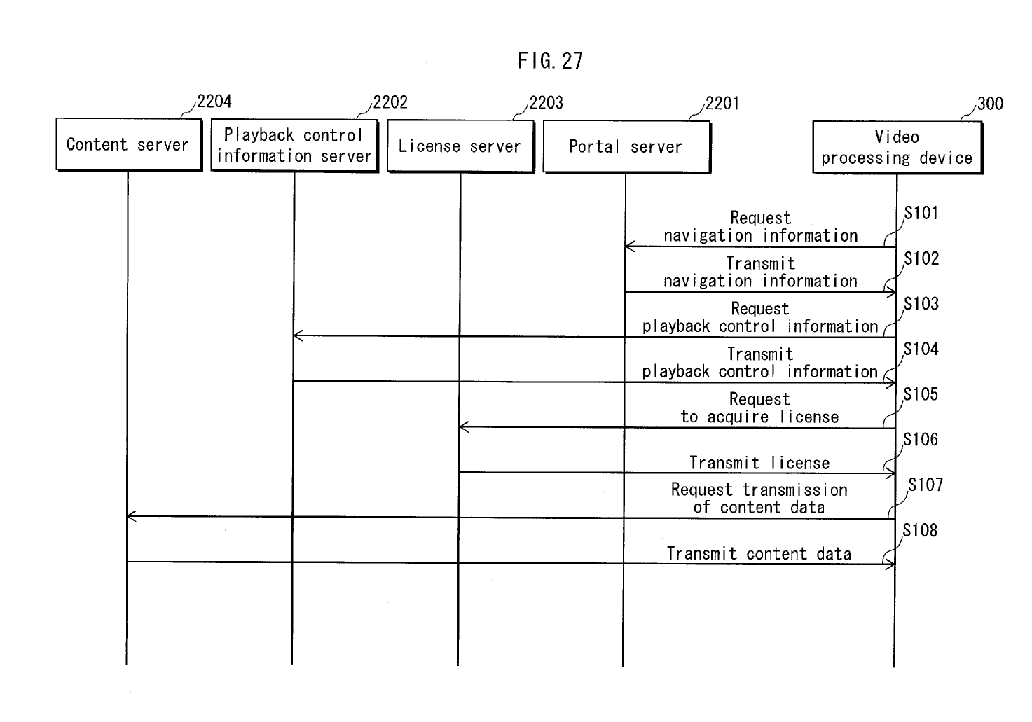

FIG. 27 shows the processing sequence by the electronic video distribution system 2200.

First, the video processing device 300 issues a request to the portal server 2201 to transmit navigation information composed of a list of distributable content and the URI of metadata necessary for playback of the content (step S101).

Upon receiving the request from the video processing device 300, the portal server 2201 transmits the navigation information to the video processing device 300 (step S102). Note that the navigation information in the present embodiment is transmitted as data in HTML (HyperText Markup Language) document format. The URI of the playback control information is described as the selected target which is referred to when clicking on a button in an HTML browser.

The video processing device 300 provides the user with a content list by displaying the received navigation information with an HTML browser. When the user selects a content to play back, the video processing device 300 issues a request to the playback control information server 2202, based on the URI of the playback control information of the selected content, to transmit the playback control information (step S103).

Upon receiving the transmission request for the playback control information, the playback control information server 2202 transmits the playback control information, which includes the ERI that describes the mode identifying information, to the video processing device 300 (step S104).

Next, the video processing device 300 refers to the playback control information. If a license is necessary to play back the content, the video processing device 300 transmits a request to the license server 2203 for the issuing of a license (step S105).

Upon receiving the request for the issuing of a license, the license server 2203 performs license issuing processing and transmits license information to the video processing device 300 (step S106).

Upon receiving the license information, the video processing device 300 issues a request, based on the playback control information, to the content server 2204. The request is for transmission of content data for the content whose playback was requested (step S107).

Upon receiving the request to transmit content data, the content server 2204 transmits content data pertaining to the content whose playback was requested to the video processing device 300 (step S108).

The video processing device 300 decodes the content data successively received from the content server 2204, processes the subtitles and the like based on the mode identifying information extracted from the ERI included in the playback control information, and outputs video for display to the display device 312. Note that transmission of the request for transmission of content data and reception of the content data use a protocol such as HTTP or RTP (Real-time Transport Protocol)/RTSP (Real Time Streaming Protocol).

### 7.7 Summary

The video processing device of the present embodiment determines the display mode for 3D subtitles and the like using the playback control information, which is metadata for content used in an electronic video distribution system that uses an IP network. As a more specific example, using the mode identifying information described in the ERI is used. Using the playback control information, which is to be processed before receiving streaming data that includes display data for 3D subtitles and the like, allows for identification of the display mode for 3D subtitles and the like before processing the streaming data that includes the display data for 3D subtitles and the like, thereby allowing for reservation of resources. This shortens the time required before display data is displayed along with the 3D video images.

### Embodiment 8

### 8.1 Outline

In Embodiment 8 of the present disclosure, mode identifying information is described in ECG (Electronic Content Guide) metadata within VOD (Video On Demand) in IPTV, and the video processing device determines the display mode for 3D subtitles and the like by extracting the mode identifying information from the ECG metadata and analyzing the extracted mode identifying information.

### 8.2 Data

The electronic video distribution system according to the present embodiment describes the mode identifying information in the ECG metadata defined in the “STD-0006 CDN Scope Service Approach Specifications Version 1.3” of the IPTV Forum Japan.

The following describes the data used in the present embodiment.

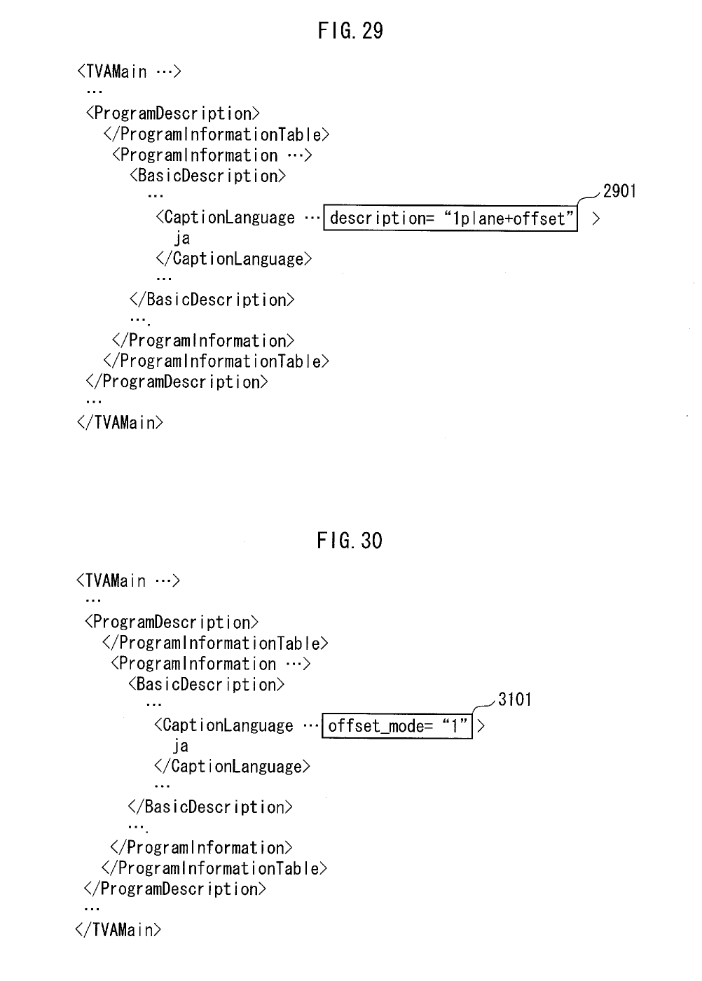

FIG. 29 shows the data structure of the ECG metadata. Description that is not necessary for the present embodiment is omitted. The ECG metadata is described in XML document format.

The present embodiment uses a CaptionLanguage tag inside a BasicDescription tag, which in turn is located inside a ProgramInformation tag. The mode identifying information is described in a description attribute 2901 of the CaptionLanguage tag.

Specifically, a value of “1 plane+offset” for the description attribute 2901 is defined as indicating that the display mode for 3D subtitles and the like is 1 plane+offset mode, whereas a value of “2 plane+offset” is defined as indicating that the display mode for 3D subtitles and the like is 2 plane+offset mode.

### 8.3 Structure

A description of the structure of the video processing device in the present embodiment is omitted for components having the same structure as the video processing device 300 of Embodiment 7, with description focusing instead on the differences. Note that for the sake of convenience, the same reference numbers as in Embodiment 7 are used for the video processing device of the present embodiment.

One difference from Embodiment 7 is that the ECG metadata is included in the metadata received by the reception unit 301. Another difference is that the determination unit 304 does not receive the ERI from the reception unit 301, but rather the ECG metadata. Yet another difference is that the determination unit 304 does not determine the display mode for 3D subtitles and the like based on the mode identifying information described in the tag defined in the EM, but rather based on the mode identifying information described in the tag defined in the ECG metadata.

### 8.4 Operations

Operations of the video processing device 300 in the present embodiment differ from Embodiment 7 first of all in that the processing in step S18 of FIG. 7 is omitted, and in that the processing in steps S16 and S17 is performed when the user selects the content to be played back, i.e. before processing in FIG. 7 other than steps S16, S17, and S18 to receive content data and to play back the content data. Another difference is that in step S16, the determination unit 304 determines the display mode for 3D subtitles and the like based on the value of the description attribute 2901 extracted from the ECG metadata. Other steps are the same as in Embodiment 7, and therefore a description is omitted.

In step S16, if the value of the description attribute 2901 for the portion of the ECG metadata corresponding to the content the user selected to play back is “1 plane+offset mode”, the determination unit 304 determines that the display mode for 3D subtitles and the like in the subtitle processor 309 is 1 plane+offset mode, whereas if the value is “2 plane+offset mode”, the determination unit 304 determines that the display mode for 3D subtitles and the like is 2 plane+offset mode.

### 8.5 Modifications to Embodiment 8

(1) In the present embodiment, “1 plane+offset” and “2 plane+offset” are used as the values of the mode identifying information described in the description attribute, but the values used for identification are not limited to these. Any value that allows for identification of the display mode for 3D subtitles and the like may be used. For example, a value of “1” for 1 plane+offset mode and a value of “2” for 2 plane+offset mode may be used.

(2) In the present embodiment, the mode identifying information is described in the value of the description attribute in the CaptionLanguage tag. Alternatively, an attribute describing the mode identifying information may be newly defined.

As shown in FIG. 30, an offset_mode attribute 3101 may be defined in the CaptionLanguage tag, and the mode identifying information may be described in this offset mode attribute.

For example, a value of “0” for the offset_mode attribute may be defined as indicating conventional 2D subtitle display instead of 3D subtitle display, a value of “1” as indicating 1 plane+offset mode, and a value of “2” as indicating 2 plane+offset mode.

(3) A new sub-tag may be added to the CaptionLanguage tag, and the mode identifying information may be described in this sub-tag.

(4) As described in modification (3) of Embodiment 7, the offset_mode tag may be an empty tag with no content. A mode may be defined as an attribute of the offset_mode, with a similar method being used for determination.

### 8.6 Supplementary Explanation

Operations of the electronic video distribution system according to the present embodiment are nearly identical to those of the electronic video distribution system 2200 according to Embodiment 7. Operations differ from the electronic video distribution system of Embodiment 7 in that in step S102 of FIG. 27, the navigation information that the portal server 2201 transmits to the video processing device 300 is the ECG metadata in which the mode identifying information is described. Note that for the sake of convenience, the same reference numbers as in Embodiment 7 are used.

The video processing device 300 of the present embodiment is provided with a function for ECG processing. The video processing device 300 processes the received ECG metadata and shows the user a content selection screen. Note that the function for ECG processing is achieved by execution of a program for ECG processing by a processor provided in the video processing device 300.

Upon user selection of a content to play back, the video processing device 300 issues a request to the playback control information server 2202 for transmission of playback control information in step S103 of FIG. 27. The request is based on the URI described in the received ECG metadata.

Subsequent processing is the same as in Embodiment 7, and therefore a description is omitted.

### 8.7 Summary

The video processing device of the present embodiment determines the display mode for 3D subtitles and the like using the mode identifying information described in the ECG metadata, which is metadata for content used in an electronic video distribution system that uses an IP network. Processing ECG metadata before receiving streaming data that includes display data for 3D subtitles and the like allows for identification of the display mode for 3D subtitles and the like before processing the streaming data that includes the display data for 3D subtitles and the like, thereby allowing for reservation of resources. This shortens the time required before display data is displayed along with the 3D video images.

### Embodiment 9

### 9.1 Outline

The video processing device of Embodiment 9 according to the present disclosure receives display data for a data broadcast not from a broadcast, but rather by IP network transmission of an IP broadcast in the form of a progressive data broadcast. At this point, the video processing device 300 acquires a URI of requested data for a data broadcast from a hyperlink descriptor in the BIT. As definitions of the BIT and on hyperlink descriptors can be found in “STD-0004 IP Broadcasting Specifications Version 1.2” of the IPTV Forum Japan, a description thereof is omitted here.

The electronic video distribution system of the present embodiment describes the mode identifying information in the HTTP or HTTPS (Hypertext Transfer Protocol over Secure Socket Layer) response header. The video processing device analyzes the response header to determine the display mode for 3D subtitles and the like.

### 9.2 Data

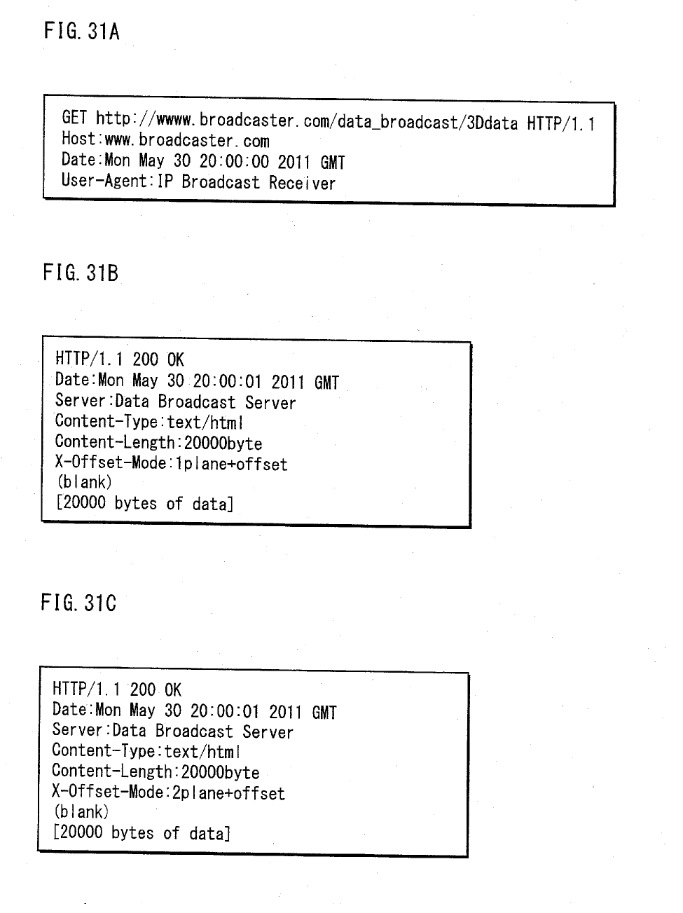

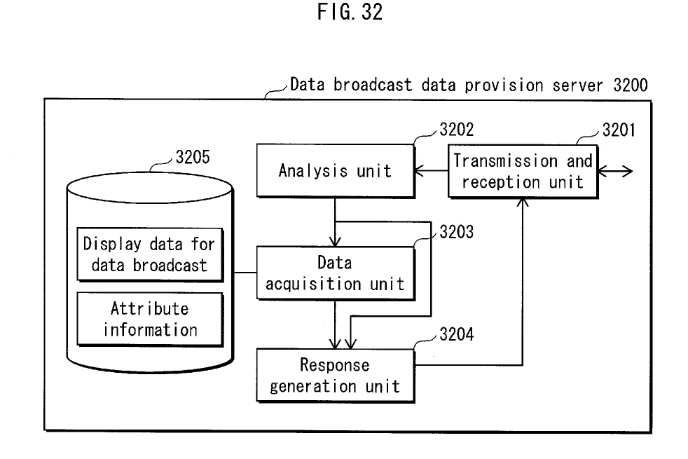

FIGS. 31A through 31C show the data structure of the HTTP header. Description that is not necessary for the present embodiment is omitted.

FIG. 31A shows an HTTP-GET request transmitted by the video processing device 300.

FIG. 31B shows an HTTP response transmitted by a server that receives the HTTP-GET request of FIG. 31A and provides data for a data broadcast. The HTTP response includes an HTTP response header in which the display mode for 3D subtitles and the like is 1 plane+offset mode.

FIG. 31C shows an HTTP response transmitted by the server that receives the HTTP-GET request of FIG. 31A and provides data for a data broadcast. The HTTP response includes an HTTP response header in which the display mode for 3D subtitles and the like is 2 plane+offset mode.

In the present embodiment, an X-Offset-Mode is defined as an extension header of the HTTP response header, and the mode identifying information is described in this extension header. Specifically, a value of “1 plane+offset” for the X-Offset-Mode is defined as indicating that the display mode for 3D subtitles and the like is 1 plane+offset mode, whereas a value of “2 plane+offset mode” is defined as indicating that the display mode for 3D subtitles and the like is 2 plane+offset mode.

### 9.3 Structure

A description of the structure of the video processing device in the present embodiment is omitted for components having the same structure as the video processing device 300 of Embodiment 7, with description focusing instead on the differences. Note that for the sake of convenience, the same reference numbers as in Embodiment 7 are used for the video processing device of the present embodiment.

One difference from Embodiment 7 is that the processor in the video processing device 300 extracts the mode identifying information from the received HTTP response header, outputting the mode identifying information to the determination unit 304. Another difference is that the determination unit 304 does not determine the display mode for 3D subtitles and the like based on the mode identifying information described in the tag defined in the ERI, but rather based on the extension header of the HTTP response header.

### 9.4 Operations

Operations of the video processing device 300 in the present embodiment differ from Embodiment 7 first of all in that the processing in step S18 of FIG. 7 is omitted, and in that the processing in steps S16 and S17 is performed when the video processing device 300 receives data for a data broadcast by HTTP. Processing other than in steps S16, S17, and S18, i.e. processing to receive content data and to play back the content data, is performed during reception of an IP broadcast. Another difference is that in step S15, a processor in the video processing device 300 executes a program for HTTP processing and receives data for a data broadcast by HTTP. Next, the processor extracts the mode identifying information from the X-Offset-Mode, which is an extension header of the HTTP response header, and outputs the mode identifying information to the determination unit 304. Yet another difference is that in step S16, the determination unit 304 determines the display mode for 3D subtitles and the like based on the value of the X-Offset-Mode. Other steps are the same as in Embodiment 7, and therefore a description is omitted.

The following describes the sequence for acquiring the data for a data broadcast.

In the present embodiment, the data for a data broadcast is assumed to be requested from the following URL: http://www.broadcaster.com/data_broadcast/3Ddata.

First, the video processing device 300 transmits the HTTP-GET request shown in FIG. 31A to the server that provides the data for a data broadcast. This HTTP-GET request specifies http://www.broadcaster.com/data_broadcast/3Ddata as the URL from which to request the data for a data broadcast.

Upon receiving the request in FIG. 31A, the server that provides the display data for a data broadcast returns the HTTP response header in FIG. 31B if, at the location from which display data for a data broadcast is requested, the display mode for 3D subtitles and the like is 1 plane+offset mode for the display data. The HTTP response includes a description of the X-Offset-Mode as an extension header. Since the value is “1 plane+offset”, the determination unit 304 determines that processing of the display data for a data broadcast by the data broadcast processor 310 is 1 plane+offset mode. On the other hand, if the display mode for 3D subtitles and the like is 2 plane+offset mode, the HTTP response header in FIG. 31C is returned. Since the value of the X-Offset-Mode is “2 plane+offset” in this case, the determination unit 304 determines that processing of the display data for a data broadcast by the data broadcast processor 310 is 2 plane+offset mode.

### 9.5 Modifications to Embodiment 9

(1) In the present Embodiment, an extension header X-Offset-Mode is defined in the HTTP response header, a value of either “1plane-offset” or “2plane-offset” is described therein, and the display mode for 3D subtitles and the like for the display data for a data broadcast is determined based on this value. The value described in the X-Offset-Mode is not, however, limited to these values. Any value that allows for identification of the 1 plane+offset mode and the 2 plane+offset mode may be used. For example, a value of “1” for the X-Offset-Mode may indicate 1 plane+offset mode, and a value of “2” may indicate 2 plane+offset mode.

(2) The name of the extension header need not be X-Offset-Mode. Any name may be used, as long as it is clear that the mode identifying information is described in the extension header.

### 9.6 Supplementary Explanation

The following describes a data broadcast data provision server according to the present embodiment.

### 9.6.1 Structure

### Data Broadcast Data Provision Server 3200

FIG. 32 is a structural diagram of a data broadcast data provision server 3200 that provides data for a data broadcast to the video processing device 300 in Embodiment 9.

The data broadcast data provision server 3200 includes a transmission and reception unit 3201, an analysis unit 3202, a data acquisition unit 3203, a response generation unit 3204, and a storage unit 3205.

The transmission and reception unit 3201 has a function to transmit and receive data to and from the video processing device 300.

The analysis unit 3202 has a function to analyze an HTTP-GET request received by the transmission and reception unit 3201 and a function to identify data to transmit to the video processing device 300.

The data acquisition unit 3203 has a function to read, from the storage unit 3205, data and attribute information for a data broadcast as identified by the analysis unit 3202.

The response generation unit 3204 has a function to receive a notification from the analysis unit 3202 of information on the HTTP-GET request, to receive the data for a data broadcast, as well as mode identifying information included in the attribute information, read from the storage unit 3205 by the data acquisition unit 3203, and to generate the HTTP response to return to the video processing device 300.

The response generated by the response generation unit 3204 is output to the transmission and reception unit 3201 and then transmitted by the transmission and reception unit 3201 to the video processing device 300.

The data broadcast data provision server 3200 includes a processor and a memory not shown in the figures. By the processor executing programs stored in the memory, the data broadcast data provision server 3200 achieves the functions of the transmission and reception unit 3201, the analysis unit 3202, the data acquisition unit 3203, and the response generation unit 3204.

The storage unit 3205 is constituted by a recording medium, such as a hard disk, and stores data for a data broadcast, display data for the stored data broadcast, and attribute information including mode identifying information for the display data.

### 9.6.2 Operations

First, the transmission and reception unit 3201 receives an HTTP-GET request, which is a request to acquire data for a data broadcast pertaining to a content, and outputs the HTTP-GET request to the analysis unit 3202.

The analysis unit 3202 analyzes the HTTP-GET request and outputs, to the data acquisition unit 3203, information that identifies the display data for a data broadcast pertaining to the requested content.

Based on the information provided by the analysis unit 3202, the data acquisition unit 3203 reads the display data for a data broadcast and the corresponding attribute information from the storage unit 3205.

Next, the data acquisition unit 3203 extracts information from the read attribute information indicating whether the display mode for 3D subtitles and the like for the display data for a data broadcast is 1 plane+offset mode or 2 plane+offset mode, outputting the extracted information to the response generation unit 3204.

The response generation unit 3204 sets the X-Offset-Mode extension header in accordance with the display mode for 3D subtitles and the like for the display data for a data broadcast. Specifically, the response generation unit 3204 generates an HTTP response including an HTTP response header in which the value of the X-Offset-Mode is set to “1 plane+offset” when the mode identifying information received from the data acquisition unit 3203 is 1 plane+offset mode and to “2 plane+offset” when the mode identifying information is 2 plane+offset mode.

The response generation unit 3204 outputs the generated HTTP response to the transmission and reception unit 3201, and the transmission and reception unit 3201 transmits the HTTP response to the video processing device 300.

### 9.7 Summary

The video processing device of the present embodiment determines the display mode for 3D subtitles and the like using the mode identifying information described in the HTTP response header, which is a transmission protocol used in an electronic video distribution system that uses an IP network. This allows for identification of the display mode for 3D subtitles and the like and for reservation of resources before processing of the display data for a data broadcast, thus shortening the time required before display data is displayed along with 3D video images.

### 10. Other Modifications

Embodiments of a video processing device according to the present disclosure have been described, but the following modifications are also possible. The present disclosure is of course not limited to a video processing device exactly as shown in the above embodiments.

(1) The video processing device of the above embodiments outputs processed video images to an external display device (for example, a 3D compatible television). Alternatively, a structure may be adopted in which the video processing device and the display device are integrated (for example, as a 3D compatible television provided with the video processing device of the present disclosure).

(2) In the above embodiments, the determination unit 304 reserves, based on the results of determination, the decoders and memory resources necessary for processing by the subtitle processor 309 and the data broadcast processor 310. Since decoders and memory of the video processing device are shared by other processes in the video processing device, however, it may not be possible to reserve decoders and memory resources when other processes (such as processes for background recording of a program or dubbing of a recorded program) are running. In this case, before performing processing for subtitles and the like, other processes may be interrupted to reserve resources for processing to display subtitles and the like, or the user may be shown a warning that display of subtitles or a data broadcast is not possible. Upon seeing the warning, the user can decide whether to interrupt another process that is running. When it becomes possible to reserve resources, for example because the user interrupts another process that is running, the video processing device may reserve resources at that point and perform processing for display data of subtitles and the like.

When resources cannot be reserved, subtitles and the like cannot be displayed together with 3D video images; however, as described above, it is possible to take user convenience into consideration by determining the display mode for 3D subtitles and the like in advance of processing of subtitles or data for a data broadcast.

(3) A portion or all of the constituent elements described in the above embodiments may all be achieved as an integrated circuit integrated into one chip or a plurality of chips, or as a computer program.

Furthermore, the constituent elements described in the above embodiments may achieve their functions by cooperation with a processor in the video processing device.

(4) The present disclosure may be the above-described methods. The present disclosure may be a non-transitory recording medium having recorded thereon a computer program that achieves the methods by a computer.

The present disclosure may also be a computer-readable recording medium, such as a flexible disk, hard disk, CD-ROM, MO, DVD, DVD-ROM, DVD-RAM, BD (Blu-ray Disc™), or semiconductor memory, on which the above-mentioned computer programs are recorded.

(5) The above embodiments and modifications may be combined with one another.

(6) As another embodiment of the present disclosure, the following describes a video processing device and modifications thereto, as well as the advantageous effects achieved thereby.

(a) A video processing device according to an embodiment of the present disclosure is for displaying a supplementary display object along with a 3D video image, the video processing device comprising: a first processing unit operable to create and output a right-view supplementary display object and a left-view supplementary display object for 3D display of the supplementary display object based on information representing the supplementary display object with one plane; a second processing unit operable to create and output a right-view supplementary display object and a left-view supplementary display object for 3D display of the supplementary display object based on information representing the supplementary display object with two planes; a reception unit receiving at least a supplementary display object playback stream and a data block, the supplementary display object playback stream containing information representing the supplementary display object with one plane or with two planes, and the data block including identifying information indicating whether the supplementary display object is represented with one plane or with two planes; a selection unit extracting the identifying information from the data block before content of the supplementary display object playback stream is referred to and selecting one of the first processing unit and the second processing unit in accordance with the identifying information; and a control unit consecutively providing the one of the first processing unit and the second processing unit selected by the selection unit with information representing the supplementary display object contained in the content of the supplementary display object playback stream and causing the one of the first processing unit and the second processing unit selected by the selection unit to create and output the right-view supplementary display object and the left-view supplementary display object.

This video processing device allows for determination of the display mode for 3D subtitles and the like without analyzing the content of the stream that includes display data for display along with 3D video images, thus shortening the time required before display data is displayed along with 3D video images.

(b) Before processing by the first processing unit and the second processing unit, the control unit may reserve a memory region corresponding to a number of planes necessary for the one of the first processing unit and the second processing unit selected by the selection unit.

This video processing device allows for reservation of image plane memory for processing the stream that includes the display data for display along with 3D video images before analyzing the content of the stream that includes the display data.

(c) The reception unit may receive a data stream in MPEG2-TS (Transport Stream) format, the data stream including a stream of content that includes a 3D video image with which the supplementary display object is displayed. The data block may be a PMT (Program Map Table) for the content included in the data stream. The selection unit may select the one of the first processing unit and the second processing unit based on the identifying information extracted from the PMT.

This video processing device allows for identification of the display mode for 3D subtitles and the like based on the mode identifying information included in the analyzed PMT before analyzing the content of the stream that includes the display data for display along with 3D video images.

(d) The PMT may include a description of information on each ES (Elementary Stream) forming the stream of content and a description of information shared throughout the stream of content. The identifying information may be included in the description of information shared throughout the stream of content. The selection unit may select the one of the first processing unit and the second processing unit based on the identifying information extracted from the description of information shared throughout the stream of content.

This video processing device allows for identification of the display mode for 3D subtitles and the like based on the mode identifying information included in the description of information shared throughout the stream of content.

(e) The PMT may include a description of information on each ES (Elementary Stream) forming the stream of content and a description of information shared throughout the stream of content. The identifying information may be included in the description of information on each ES. The selection unit may select the one of the first processing unit and the second processing unit based on the identifying information extracted from the description of information on each ES.

This video processing device allows for identification of the display mode for 3D subtitles and the like based on the mode identifying information included in the description of information on each ES forming the content.

(f) The description of information on each ES may include a data component descriptor. The identifying information may be included in the data component descriptor. The selection unit may select the one of the first processing unit and the second processing unit based on the identifying information extracted from the data component descriptor.

This video processing device allows for identification of the display mode for 3D subtitles and the like based on the mode identifying information described in the data component descriptor within the information on each ES forming the content.

(g) The reception unit may receive a data stream in MPEG2-TS (Transport Stream) format from a broadcasting station. The data block may be an EIT (Event Information Table) included in the data stream. The EIT may include a description of information on a 3D video image with which the supplementary display object is displayed. The identifying information may be included in the description of information on the 3D video image with which the supplementary display object is displayed. The selection unit may select the one of the first processing unit and the second processing unit based on the identifying information extracted from the description of information on the 3D video image with which the supplementary display object is displayed.

This video processing device allows for identification of the display mode for 3D subtitles and the like based on the mode identifying information included in the EIT transmitted before transmission of the stream that includes the display data for display along with 3D video images.

(h) The description of information on a 3D video image with which the supplementary display object is displayed may include a data content descriptor. The identifying information may be included in the data content descriptor. The selection unit may select the one of the first processing unit and the second processing unit based on the identifying information extracted from the data content descriptor.

This video processing device allows for identification of the display mode for 3D subtitles and the like based on the mode identifying information described in the data content descriptor included in the EIT.

(i) The reception unit may receive at least streaming data distributed over an IP (Internet Protocol) network. The data block may be included in the playback control information. The selection unit may select the one of the first processing unit and the second processing unit based on the identifying information extracted from the data block.

This video processing device allows for identification of the display mode for 3D subtitles and the like based on the mode identifying information described in the playback control information for playing back the IPTV streaming data.

(j) The reception unit may receive at least VOD (Video On Demand) navigation data distributed over an IP (Internet Protocol) network and VOD streaming data including a stream of content that includes a 3D video image with which the supplementary display object is displayed. The data block may be included in the navigation data. The selection unit may select the one of the first processing unit and the second processing unit based on the identifying information extracted from the data block.

This video processing device allows for identification of the display mode for 3D subtitles and the like based on the mode identifying information described in the navigation data that is processed before reception of the VOD streaming data.

(k) The reception unit may receive a data stream in MPEG2-TS (Transport Stream) format, the data stream including a stream of content that includes a 3D video image with which the supplementary display object is displayed. The video processing device may further comprise an acquisition unit acquiring the supplementary display object playback stream over an IP (Internet Protocol) network using HTTP (HyperText Transfer Protocol) based on hyperlink descriptor information described in a BIT (Broadcaster Information Table) for the content included in the data stream. The data block may be an HTTP response header that is a response to a request for acquisition. The selection unit may select the one of the first processing unit and the second processing unit based on the identifying information extracted from the response header.

This video processing device allows for identification of the display mode for 3D subtitles and the like based on the mode identifying information described in the HTTP response header.

(1) A video processing method according to an embodiment of the present disclosure is used in a video processing device for displaying a supplementary display object along with a 3D video image, the video processing device method comprising: a first processing step of creating and outputting a right-view supplementary display object and a left-view supplementary display object for 3D display of the supplementary display object based on information representing the supplementary display object with one plane; a second processing step of creating and outputting a right-view supplementary display object and a left-view supplementary display object for 3D display of the supplementary display object based on information representing the supplementary display object with two planes; a reception step of receiving at least a supplementary display object playback stream and a data block, the supplementary display object playback stream containing information representing the supplementary display object with one plane or with two planes, and the data block including identifying information indicating whether the supplementary display object is represented with one plane or with two planes; a selection step of extracting the identifying information from the data block before content of the supplementary display object playback stream is referred to and selecting one of the first processing step and the second processing step in accordance with the identifying information; and a control step of consecutively providing the one of the first processing step and the second processing step selected by the selection unit with information representing the supplementary display object contained in the content of the supplementary display object playback stream and causing the one of the first processing step and the second processing step selected by the selection step to create and output the right-view supplementary display object and the left-view supplementary display object.

This video processing method allows for determination of the display mode for 3D subtitles and the like without analyzing the content of the stream that includes display data for display along with 3D video images, thus shortening the time required before display data is displayed along with 3D video images.

(m) A non-transitory recording medium having recorded thereon a video processing program according to an embodiment of the present disclosure causes a video processing device to display a supplementary display object along with a 3D video image, the video processing device program causing the video processing device to perform: a first processing step of creating and outputting a right-view supplementary display object and a left-view supplementary display object for 3D display of the supplementary display object based on information representing the supplementary display object with one plane; a second processing step of creating and outputting a right-view supplementary display object and a left-view supplementary display object for 3D display of the supplementary display object based on information representing the supplementary display object with two planes; a reception step of receiving at least a supplementary display object playback stream and a data block, the supplementary display object playback stream containing information representing the supplementary display object with one plane or with two planes, and the data block including identifying information indicating whether the supplementary display object is represented with one plane or with two planes; a selection step of extracting the identifying information from the data block before content of the supplementary display object playback stream is referred to and selecting one of the first processing step and the second processing step in accordance with the identifying information; and a control step of consecutively providing the one of the first processing step and the second processing step selected by the selection unit with information representing the supplementary display object contained in the content of the supplementary display object playback stream and causing the one of the first processing step and the second processing step selected by the selection step to create and output the right-view supplementary display object and the left-view supplementary display object.

This recording medium having recorded thereon a video processing program allows for determination of the display mode for 3D subtitles and the like without analyzing the content of the stream that includes display data for display along with 3D video images, thus shortening the time required before display data is displayed along with 3D video images.

(n) An integrated circuit according to an embodiment of the present disclosure forms a video processing device for displaying a supplementary display object along with a 3D video image, the integrated circuit comprising: a first processing unit operable to create and output a right-view supplementary display object and a left-view supplementary display object for 3D display of the supplementary display object based on information representing the supplementary display object with one plane; a second processing unit operable to create and output a right-view supplementary display object and a left-view supplementary display object for 3D display of the supplementary display object based on information representing the supplementary display object with two planes; a reception unit receiving at least a supplementary display object playback stream and a data block, the supplementary display object playback stream containing information representing the supplementary display object with one plane or with two planes, and the data block including identifying information indicating whether the supplementary display object is represented with one plane or with two planes; a selection unit extracting the identifying information from the data block before content of the supplementary display object playback stream is referred to and selecting one of the first processing unit and the second processing unit in accordance with the identifying information; and a control unit consecutively providing the one of the first processing unit and the second processing unit selected by the selection unit with information representing the supplementary display object contained in the content of the supplementary display object playback stream and causing the one of the first processing unit and the second processing unit selected by the selection unit to create and output the right-view supplementary display object and the left-view supplementary display object.

This integrated circuit forming a video processing device allows for determination of the display mode for 3D subtitles and the like without analyzing the content of the stream that includes display data for display along with 3D video images, thus shortening the time required before display data is displayed along with 3D video images.

### INDUSTRIAL APPLICABILITY

The video processing device of the present disclosure is useful in video processing devices that display subtitles and data for a data broadcast along with 3D video images.

### REFERENCE SIGNS LIST

300 video processing device
301 reception unit
302 demultiplexer
303 analysis unit
304 determination unit
305 video decoder
306 offset acquisition unit
307 left-view video output unit
308 right-view video output unit
309 subtitle processor
310 data broadcast processor
311 display video output unit
701 subtitle decoder
702 subtitle plane memory
703 left-subtitle shift output unit
704 right-subtitle shift output unit
801 left-subtitle decoder
802 left-subtitle plane memory
803 left-subtitle shift output unit
804 right-subtitle decoder
805 right-subtitle plane memory
806 right-subtitle shift output unit

1. A video processing device for displaying a supplementary display object along with a 3D video image, the video processing device comprising:
a first processing unit operable to create and output a right-view supplementary display object and a left-view supplementary display object for 3D display of the supplementary display object based on information representing the supplementary display object with one plane;
a second processing unit operable to create and output a right-view supplementary display object and a left-view supplementary display object for 3D display of the supplementary display object based on information representing the supplementary display object with two planes;
a reception unit receiving at least a supplementary display object playback stream and a data block, the supplementary display object playback stream containing information representing the supplementary display object with one plane or with two planes, and the data block including identifying information indicating whether the supplementary display object is represented with one plane or with two planes;
a selection unit extracting the identifying information from the data block before content of the supplementary display object playback stream is referred to and selecting one of the first processing unit and the second processing unit in accordance with the identifying information; and
a control unit consecutively providing the one of the first processing unit and the second processing unit selected by the selection unit with information representing the supplementary display object contained in the content of the supplementary display object playback stream and causing the one of the first processing unit and the second processing unit selected by the selection unit to create and output the right-view supplementary display object and the left-view supplementary display object.

2. The video processing device of claim 1, wherein
before processing by the first processing unit and the second processing unit, the control unit reserves a memory region corresponding to a number of planes necessary for the one of the first processing unit and the second processing unit selected by the selection unit.

3. The video processing device of claim 2, wherein
the reception unit receives a data stream in MPEG2-TS (Transport Stream) format, the data stream including a stream of content that includes a 3D video image with which the supplementary display object is displayed,
the data block is a PMT (Program Map Table) for the content included in the data stream, and
the selection unit selects the one of the first processing unit and the second processing unit based on the identifying information extracted from the PMT.

4. The video processing device of claim 3, wherein
the PMT includes descriptions of information on each ES (Elementary Stream) forming the stream of content and descriptions of information shared throughout the stream of content,
the identifying information is included in the description of information shared throughout the stream of content, and
the selection unit selects the one of the first processing unit and the second processing unit based on the identifying information extracted from the description of information shared throughout the stream of content.

5. The video processing device of claim 3, wherein
the PMT includes descriptions of information on each ES (Elementary Stream) forming the stream of content and descriptions of information shared throughout the stream of content,
the identifying information is included in the description of information on each ES, and
the selection unit selects the one of the first processing unit and the second processing unit based on the identifying information extracted from the description of information on each ES.

6. The video processing device of claim 5, wherein
the description of information on each ES includes a data component descriptor,
the identifying information is included in the data component descriptor, and
the selection unit selects the one of the first processing unit and the second processing unit based on the identifying information extracted from the data component descriptor.

7. The video processing device of claim 2, wherein
the reception unit receives a data stream in MPEG2-TS (Transport Stream) format from a broadcasting station,
the data block is an EIT (Event Information Table) included in the data stream,
the EIT includes a description of information on a 3D video image with which the supplementary display object is displayed,
the identifying information is included in the description of information on the 3D video image with which the supplementary display object is displayed, and
the selection unit selects the one of the first processing unit and the second processing unit based on the identifying information extracted from the description of information on the 3D video image with which the supplementary display object is displayed.

8. The video processing device of claim 7, wherein
the description of information on a 3D video image with which the supplementary display object is displayed includes a data content descriptor,
the identifying information is included in the data content descriptor, and
the selection unit selects the one of the first processing unit and the second processing unit based on the identifying information extracted from the data content descriptor.

9. The video processing device of claim 2, wherein
the reception unit receives at least streaming data distributed over an IP (Internet Protocol) network,
the data block is included in the playback control information, and
the selection unit selects the one of the first processing unit and the second processing unit based on the identifying information extracted from the data block.

10. The video processing device of claim 2, wherein
the reception unit receives at least VOD (Video On Demand) navigation data distributed over an IP (Internet Protocol) network and VOD streaming data including a stream of content that includes a 3D video image with which the supplementary display object is displayed,
the data block is included in the navigation data, and
the selection unit selects the one of the first processing unit and the second processing unit based on the identifying information extracted from the data block.

11. The video processing device of claim 2, wherein
the reception unit receives a data stream in MPEG2-TS (Transport Stream) format, the data stream including a stream of content that includes a 3D video image with which the supplementary display object is displayed,
the video processing device further comprises an acquisition unit acquiring the supplementary display object playback stream over an IP (Internet Protocol) network using HTTP (HyperText Transfer Protocol) based on hyperlink descriptor information described in a BIT (Broadcaster Information Table) for the content included in the data stream,
the data block is an HTTP response header that is a response to a request for acquisition, and
the selection unit selects the one of the first processing unit and the second processing unit based on the identifying information extracted from the response header.

12. A video processing method used in a video processing device for displaying a supplementary display object along with a 3D video image, the video processing device method comprising:
a first processing step of creating and outputting a right-view supplementary display object and a left-view supplementary display object for 3D display of the supplementary display object based on information representing the supplementary display object with one plane;
a second processing step of creating and outputting a right-view supplementary display object and a left-view supplementary display object for 3D display of the supplementary display object based on information representing the supplementary display object with two planes;
a reception step of receiving at least a supplementary display object playback stream and a data block, the supplementary display object playback stream containing information representing the supplementary display object with one plane or with two planes, and the data block including identifying information indicating whether the supplementary display object is represented with one plane or with two planes;
a selection step of extracting the identifying information from the data block before content of the supplementary display object playback stream is referred to and selecting one of the first processing step and the second processing step in accordance with the identifying information; and
a control step of consecutively providing the one of the first processing step and the second processing step selected by the selection unit with information representing the supplementary display object contained in the content of the supplementary display object playback stream and causing the one of the first processing step and the second processing step selected by the selection step to create and output the right-view supplementary display object and the left-view supplementary display object.

13. A non-transitory recording medium having recorded thereon a video processing program that causes a video processing device to display a supplementary display object along with a 3D video image, the video processing device program causing the video processing device to perform:
a first processing step of creating and outputting a right-view supplementary display object and a left-view supplementary display object for 3D display of the supplementary display object based on information representing the supplementary display object with one plane;
a second processing step of creating and outputting a right-view supplementary display object and a left-view supplementary display object for 3D display of the supplementary display object based on information representing the supplementary display object with two planes;
a reception step of receiving at least a supplementary display object playback stream and a data block, the supplementary display object playback stream containing information representing the supplementary display object with one plane or with two planes, and the data block including identifying information indicating whether the supplementary display object is represented with one plane or with two planes;
a selection step of extracting the identifying information from the data block before content of the supplementary display object playback stream is referred to and selecting one of the first processing step and the second processing step in accordance with the identifying information; and
a control step of consecutively providing the one of the first processing step and the second processing step selected by the selection unit with information representing the supplementary display object contained in the content of the supplementary display object playback stream and causing the one of the first processing step and the second processing step selected by the selection step to create and output the right-view supplementary display object and the left-view supplementary display object.

14. An integrated circuit forming a video processing device for displaying a supplementary display object along with a 3D video image, the integrated circuit comprising:
a first processing unit operable to create and output a right-view supplementary display object and a left-view supplementary display object for 3D display of the supplementary display object based on information representing the supplementary display object with one plane;
a second processing unit operable to create and output a right-view supplementary display object and a left-view supplementary display object for 3D display of the supplementary display object based on information representing the supplementary display object with two planes;
a reception unit receiving at least a supplementary display object playback stream and a data block, the supplementary display object playback stream containing information representing the supplementary display object with one plane or with two planes, and the data block including identifying information indicating whether the supplementary display object is represented with one plane or with two planes;
a selection unit extracting the identifying information from the data block before content of the supplementary display object playback stream is referred to and selecting one of the first processing unit and the second processing unit in accordance with the identifying information; and
a control unit consecutively providing the one of the first processing unit and the second processing unit selected by the selection unit with information representing the supplementary display object contained in the content of the supplementary display object playback stream and causing the one of the first processing unit and the second processing unit selected by the selection unit to create and output the right-view supplementary display object and the left-view supplementary display object.
